(19) United States
(12) Patent Application Publication
(10) Pub. No.: US 2007/0043638 A1
(43) Pub. Date: Feb. 22, 2007

(54) System architecture and related methods for monitoring financial positions of an entity on a group-wide basis

(76) Inventors: Mark A. Tabs, Katonah, NY (US); Timothy K. Maxcy, Weston, CT (US); Benno Moser, Wallisellen (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/206,942

(22) Filed: Aug. 19, 2005

(51) Int. Cl. G06Q 40/00

(52) U.S. Cl. 705/35

(57) ABSTRACT

Systems and methods are provided for supporting financial reporting obligations, such as legal or regulatory reporting requirements. In accordance with one implementation, a computerized system is provided for monitoring financial positions of an entity on a group-wide basis. The system includes one or more user interfaces for defining netting and holding rules. The holding rules define financial positions that are reportable in each jurisdiction where the entity holds a financial position. The netting rules define how to aggregate financial positions. The computerized system may also comprise a plurality of source systems for electronically storing and transmitting financial position data of the entity, and a calculation engine adapted to electronically receive the financial position data transmitted from each of the plurality of source systems and to aggregate the financial position data in accordance with the netting and holding rules.

### BACKGROUND

1. Field of the Invention

The present invention generally relates to computerized systems and methods for supporting financial reporting obligations, such legal or regulatory requirements concerning the reporting of financial positions. More particularly, the invention relates to systems and methods that facilitate the monitoring and reporting of financial positions on a group-wide or consolidated basis.

2. Description of the Related Art

Banks, investment firms and other institutions (hereinafter “financial institutions”) have a duty to monitor and report their financial positions. These reporting obligations can vary according to jurisdiction and are typically defined by local or regional regulations and laws. For example, in the United States, bank holding companies (BHCs) are regulated and supervised by the Federal Reserve. Among other requirements, BHCs are obligated to monitor and report their financial positions in accordance with the Bank Holding Company Act (BHCA).

In the course of maintaining legal compliance and meeting report obligations, financial institutions monitor and track various data. For example, financial institutions may identify financial positions above a prescribed threshold, identify whether they have exceeded a threshold, identify financial positions that have dropped below a threshold, and/or identify financial positions that have moved up or down by a predefined percentage or limit. In addition, financial institutions will often commit resources to investigate potential filings to confirm the correctness of data, and track and record filings with local regulators.

Bank and other financial institutions that maintain a global presence also face the challenge of complying with each country's or region's unique set of reporting rules. In many cases, this requires the financial institution to aggregate position data for the entire group to determine the total percentage of holdings in a given jurisdiction. Different reporting requirements may exist depending on the capacity of the holding (e.g., proprietary, discretionary managed, custody, or collateral), the nature of the issuer (e.g., defense manufacturer, bank, insurer, media company, etc.), or the type of financial holding or product (e.g., cash equity, options (call/puts), warrants, convertibles, etc.). By way of example, a large financial institution with legal entities throughout the world may be required to file reports or otherwise satisfy legal obligations in the following categories: reports the financial institution must file when the holdings or deemed holdings of the financial institution in a particular issuer exceed a predefined threshold (e.g., 2% to 5%); reports the financial institution must file with respect to its holdings because of who it is (e.g., bank, issuer of research, broker dealer); and/or reports the financial institution must file or permissions it must seek because of the nature of the issuer.

Because the rules for calculating positions are complex and jurisdiction-dependent, financial institutions may use local compliance teams to monitor positions and adhere to reporting requirements. However, such an approach is error prone and generally inefficient. Further, the lack of a centralized approach makes it difficult to aggregate position data or quickly identify events triggering reporting obligation(s). Moreover, ever-changing regulatory requirements and decreasing reporting timeframes require the frequent modification of compliance processes and often stress committed IT and/or human resources.

In the view of the foregoing, there is a need for improved solutions for supporting financial reporting obligations. For example, there is a need for computerized systems and methods that enable financial institutions to fully comply with reporting obligations in a timely and precise manner. Further, there is a need for a more centralized approach that facilitates the monitoring and reporting of financial positions on a group-wide or consolidated basis. Moreover, there is a need for improved systems and methods that provide more flexibility and options to end users.

### SUMMARY OF THE INVENTION

Consistent with the principles of the present invention, systems are provided for supporting financial reporting obligations, such as legal or regulatory reporting requirements. In addition, systems consistent with the present invention are provided for monitoring and reporting of financial positions on a group-wide basis. Moreover, systems are disclosed for providing more flexibility and options to end users

In accordance with one embodiment, a computerized system is provided for monitoring financial positions of an entity on a group-wide basis. The system includes one or more user interfaces for defining netting and holding rules. The holding rules define financial positions that are reportable in each jurisdiction where the entity holds a financial position. The netting rules define how to aggregate financial positions. The computerized system may also comprise a plurality of source systems for electronically storing and transmitting financial position data of the entity, and a calculation engine adapted to electronically receive the financial position data transmitted from each of the plurality of source systems and to aggregate the financial position data in accordance with the netting and holding rules.

In accordance with another embodiment, a computerized system is provided for monitoring financial positions of an entity on a group-wide basis. The system includes means for defining netting and holding rules. The holding rules define financial positions that are reportable in each jurisdiction where the entity holds a financial position. The netting rules define how to aggregate financial positions. The computerized system may also comprise means for electronically storing and transmitting financial position data of the entity, and means for electronically receiving the financial position data transmitted from each of the plurality of source systems and to aggregate the financial position data in accordance with the netting and holding rules.

In accordance with yet another embodiment, a computer-implemented method is provided for monitoring financial positions of an entity on a group-wide basis. The method comprises the steps of defining netting rules and holding rules, the holding rules defining what financial positions are reportable in each jurisdiction where the entity holds a financial position, and the netting rules defining how to aggregate financial positions. In addition, the method comprises electronically storing and transmitting, by a plurality of source systems, financial position data of the entity. The method further comprises the step of electronically receiving financial position data transmitted from each of the plurality of source systems and aggregating the financial position data in accordance with the netting rules and the holding rules.

In still a further embodiment, one or more user interfaces for defining reporting rules are provided. The reporting rules may be user-defined and specify criteria for triggering alerts for reporting requirements in one or more jurisdictions. As further disclosed herein, the criteria may comprise a holding threshold or a position movement. Moreover, one or more user interfaces for an alert dashboard may be provided for displaying alerts or warnings to end users based on the reporting rules. The dashboard display may facilitate further investigation of financial positions and/or the reporting of positions.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary system configuration for facilitating the monitoring and reporting of financial positions on an aggregated basis;

FIG. 2 is a detailed diagram of an exemplary configuration of a calculation engine;

FIG. 3 illustrates an exemplary structure of a financial institution comprising a plurality of business groups and legal entities;

FIG. 4 shows a flow diagram of an exemplary method for facilitating the monitoring and reporting of financial positions on an aggregated basis;

FIG. 5 illustrates a flow diagram of an exemplary method for defining new netting rules or accessing and modifying existing netting rules;

FIG. 6 illustrates a flow diagram of an exemplary method for defining new holding rules or accessing and modifying existing holding rules;

FIG. 7 illustrates a flow diagram of an exemplary method for defining new reporting rules or accessing and modifying existing reporting rules;

FIG. 8 shows a flow diagram of an exemplary method for displaying a dashboard of legal entities and alerts associated with the legal entities, and accessing the alerts and generating reports based on the alerts;

FIGS. 9A-B illustrate exemplary graphical user interfaces (GUIs) for defining new netting rules or accessing and modifying existing netting rules;

FIGS. 10A-B illustrate exemplary GUIs for defining new holding rules or accessing and modifying existing holding rules;

FIGS. 11A-B illustrate exemplary GUIs for defining new reporting rules or accessing and modifying existing reporting rules;

FIGS. 12A-C illustrate exemplary GUIs for displaying a dashboard of legal entities and alerts associated with the legal entities, and accessing the alerts and generating reports based on the alerts; and

FIGS. 13A-B illustrate examples of how to select financial positions based on a holding rule, and then aggregate selected financial positions based on a netting rule associated with the holding rule.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

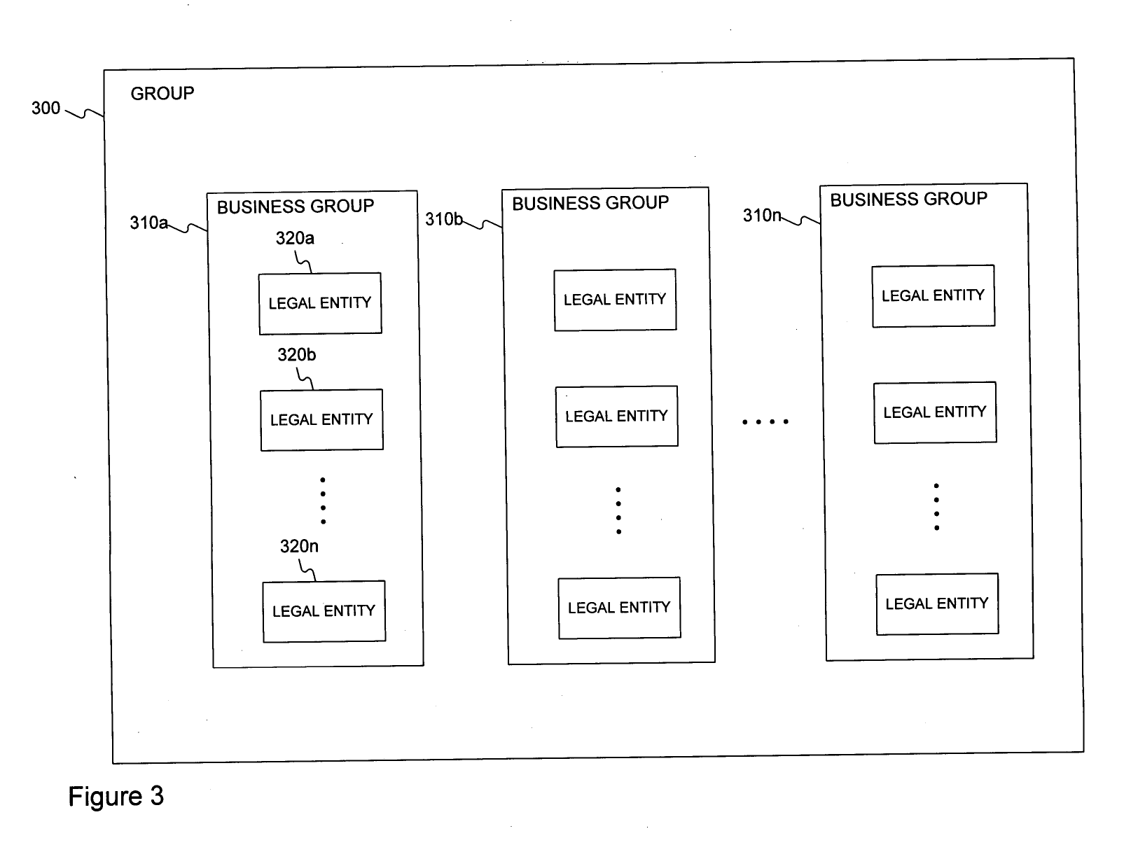

Consistent with embodiments of the present invention, computerized systems and methods are provided for facilitating the monitoring and reporting of financial positions of an entity. As used herein, the term “entity” refers to any financial institution or other entity with reporting obligations concerning its financial positions or holdings. Examples of entities includes banks, investment firms, hedge funds, mutual funds, insurance companies, pension funds, trusts and the like. An entity, such as a large financial institution, may structured with one or more business groups and/or legal entities (see, for example, FIG. 3). The monitoring of financial positions or holdings of the various business groups or legal entities may be required on an aggregated basis to meet reporting obligations in each of the jurisdictions in which the financial institution holds positions. In this disclosure, the terms “entity” and “financial institution” are used interchangeably and should not be deemed to limit the scope or applicability of the invention.

As will be appreciated by those skilled in the art, embodiments of the invention can be adapted to monitor financial positions of an entity at any level, including on a regional or group-wide basis. For this purpose, computerized systems and methods are provided for calculating financial positions on an aggregated basis. The disclosed embodiments and components thereof may be implemented through any suitable combination of hardware, software and/or firmware.

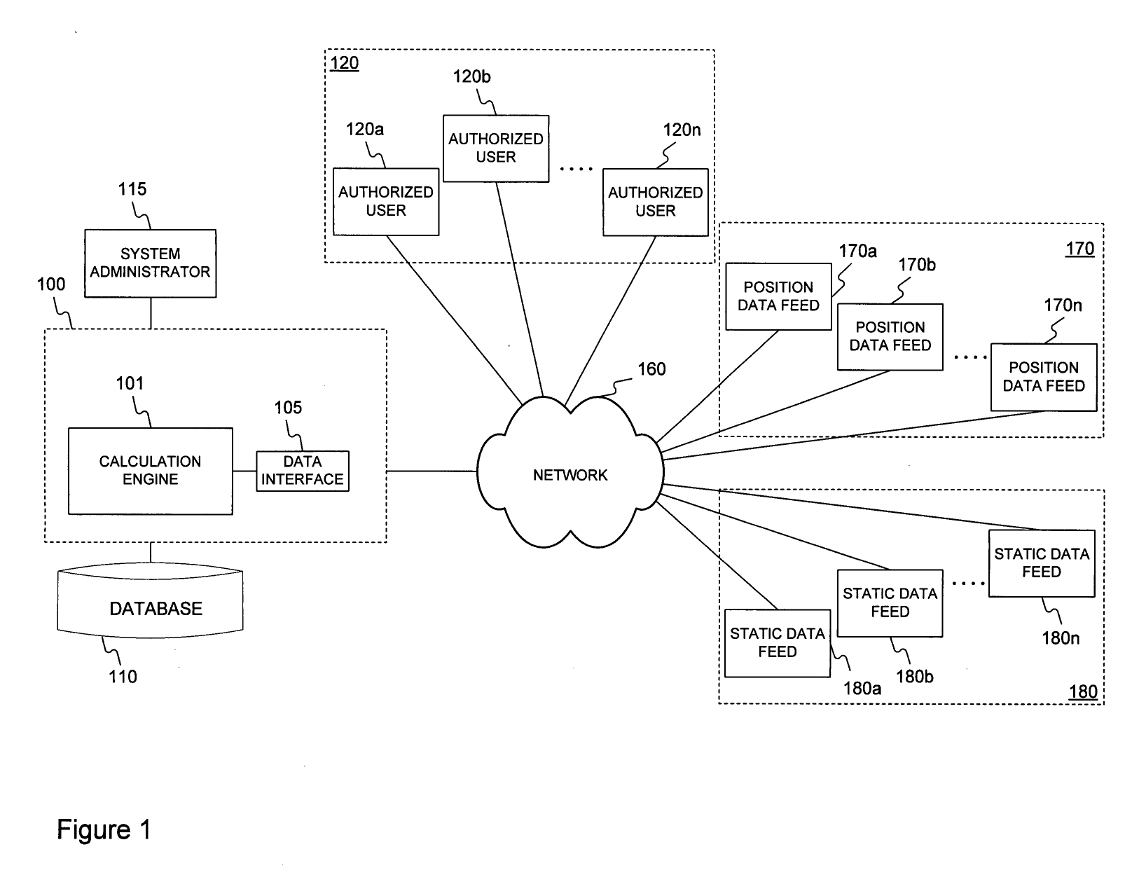

In accordance with embodiments of the invention, a computerized system may be implemented with one or more interfaces to enable a user to define netting rules and holding rules. The holding rules define the financial positions that are reportable in each jurisdiction where the entity holds a financial position. The netting rules define how to aggregate the financial positions. Further, a plurality of source systems or position data feeds may be provided that electronically store and transmit financial position data of the entity to a server having a calculation engine (see, for example, FIG. 1). In one embodiment, the server is centralized and the calculation engine is adapted to electronically receive financial position data transmitted from each of the source systems and to aggregate the financial position data in accordance with the netting and holding rules.

Embodiments of the invention also related to computerized methods and computer-readable media containing instructions for performing such methods. For example, according to an embodiment of the invention, a method may be provided that comprises the steps of providing netting rules to define how to aggregate financial positions, and providing holding rules to define what financial positions are reportable in each jurisdiction where the entity holds a financial position. The method may also comprise receiving financial position data from a plurality of source systems, and aggregating the financial position data from the source systems to determine the financial positions of the entity on an aggregated basis, wherein the financial position data is aggregated in accordance with the netting and holding rules.

In still further embodiments, reporting rules may be defined by a user or otherwise provided. The reporting rules may specify criteria for triggering alerts or warnings in accordance with reporting requirements in specific jurisdiction(s). In one embodiment, the criteria defines a holding threshold and/or position movement. Moreover, an alert dashboard may be provided for displaying alerts or warnings to end users concerning potentially reportable positions. Such a dashboard display may enable users to view alerts in one or more jurisdictions and/or at one or more levels. Further, the dashboard may facilitate further investigation of financial positions and reporting for legal compliance, as needed.

Exemplary System Configuration

FIG. 1 is a block diagram of an exemplary system configuration 10, consistent with the principles of the present invention. System 10 may facilitate the monitoring and reporting of financial positions of an entity on a group-wide or global basis. Specifically, the components of system 10 may be adapted to receive and aggregate financial position data from a plurality of position data feeds, and generate alerts concerning reportable financial positions. Further, one or more interfaces may be provided in system 10 to enable authorized end users to define or modify netting rules, holding rules, and/or reporting rules.

As shown in FIG. 1, system 10 includes a server 100 with a calculation engine 101 and, optionally, a data interface 105. Server 100 is connected to a database 110 for storing data, such as position data received from a plurality of position data feeds 170a-170n (also referred to as “source systems” herein), as well as data representing various rules (e.g., netting rules, holding rules and reporting rules) and/or other input provided from authorized users 120a-120n. Data from positions data feeds 170a-170n and authorized users 120a-120n may be sent to server 100 via a network 160. In addition, market and/or other static data from static data feeds 180a-180n (e.g., Bloomberg, Ex-share, TELEKURS, etc.) may be electronically provided to server 100 via network 160. Each of these components is described in greater detail below.

As will be appreciated by those skilled in the art, the number and orientation of the components illustrated in FIG. 1 are merely are examples and do not limit the scope of the invention. Therefore, other arrangements and sets of components are feasible, consistent with the principles of the invention. Further, it is noted that any combination of the components in system 10 may be owned and operated by a financial institution or entity. Moreover, several of the components (such as static data feeds 180a-180n and server 100) may by owned and operated by a third party for the purposes of providing data and/or otherwise facilitating an entity to monitor its financial positions.

Position data feeds 170a-170n may serve as source systems for providing financial position data of an entity. The position data may represent financial positions of the entity, including any business group, unit or legal entity that is part of the entity. Further, the financial positions may correspond to any type of financial product, holding or security. Examples of financial product types include cash equity, options (calls/puts), warrants, convertibles, and other instruments that can be converted into equity. Examples of position data that may be provided by data feeds 170a-170n include financial product type, class of financial product, issuer of the financial product traded, quantity traded, type of trade (such as long or short), and/or date/time of trade. The position data from position data feeds 170a-170n may be sent on a frequent or periodic basis (e.g., daily) to server 100. In one embodiment, position data feeds are sent on a daily basis to provide aggregate trade data and/or other updates at the end of a business day or during the evening. In another embodiment, position data feeds are sent hourly, substantially simultaneously or in real-time. All financial position data provided by position data feeds 170a-1 70n may be stored in database 110.

Authorized users 120a-120n represent authorized end users of system 10. Examples of authorized users 120 include compliance officers, managers, or any users with authority to view alerts or modify rules. Access rights and privileges of each authorized user may be controlled by a system administrator 115. Conventional security models and techniques may be used for granting access rights and privileges to users 120a-120n. As further disclosed herein, the rights and privileges of each authorized user may enable the user to define netting, holding and/or reporting rules, as well as view alerts or warnings generated by calculation engine 101.

Consistent with embodiments of the invention, the rights and privileges assigned to a user may control the user's access to system 10 at any level (e.g., local or regional) or combination of levels. In one embodiment, authorized users comprise members of a financial institution's compliance team(s), with the access rights and privileges of each user being set according to the user's role(s) and/or the team(s) that the user belongs to.

Static data feeds 180a-180n provide static data such as market data or, more particularly, issue and issuer data related to financial holdings or products. Issue data for each financial holding or product may include, for example, class (e.g., Class A or Class B stock), underlying product ID, underlying product ID source (e.g., ISIN, Reuter/Quick code for Japan), number of outstanding shares, outstanding product source, exchange(s) of issue (e.g., New York Stock Exchange, London Stock Exchange, Swiss Exchange), conversion factor, and/or outstanding issue quantity. Issuer data may include, for example, issuer ID, country code of original product issuer, country code of underlying issuer, domicile of issuer, issue to issuer links, and/or industry codes of underlying issuer. Examples of static data feeds include commercially available sources of market and/or other static data, such as Bloomberg, Ex-share, TELEKURS, etc. Data from static data feeds 180a-180n may be stored in database 110 and used by calculation engine 101 to determine the percentage of ownership that an entity has in any particular holding (e.g., expressed as a percentage (%) owned by the entity relative to the shares outstanding of the issue/issuer).

In operation, server 100 receives data from the various data sources in system 10 (i.e., authorized users 120a-120n, position data feeds 170a-170n, and static data feeds 180a-180n). The received data may be filtered, mapped and/or otherwise processed prior to analysis by calculation engine 101 or storage in database 110. For example, as described below, a data interface 105 may be provided to filter and map data from position data feeds 170a-170n and/or static data feeds 180a-180n. Such processing may normalize the data and catch exceptions or errors. Subsequent to the processing of financial position data, calculation engine 101 may aggregate the data based on applicable holding and netting rules. With the aggregated financial position data, alerts or warnings may be provided based on specified reporting rules to inform authorized end users and/or facilitate compliance with reporting obligations. In one embodiment, the alerts or warnings are electronically presented to authorized users 120a-120n via a dashboard or similar display.

The components shown in FIG. 1, including server 100, database 110, a system administrator 115, authorized users 120a-120n, position data feeds 170a-170n, and static data feeds 180a-180n, may comprise a computing device or platform, such as a computer, laptop, server, mainframe and the like. By way of example, such a computing device may include a central processing unit (CPU), a disk drive, a memory, and/or a network access device. Further, server 100 may be embodied as a central server (as represented in FIG. 1) or any number of distributed servers (not shown), and may comprise software applications or modules for implementing calculation engine 101 and data interface 105.

The CPU of a computing device may be any appropriate processor or set of processors for executing program instructions. Memory may be RAM or any another permanent, semi-permanent, or temporary storage device, including ROM and flash memory. Disk drives may comprise a hard disk drive, an optical drive, or any other type of data storage device.

The network access device of a computing device may be a modem, a cable modem, an Ethernet card, a T1 line connector, or any other access device for connecting a respective system component (e.g., server 100, database 110, system administrator 115, authorized users 120, position data feeds 170, static data feeds 180) to another system component or connecting a respective system component directly to network 160. Network 160 may be any combination of wired or wireless networks for facilitating the electronic communication of data. By way of example, network 160 may comprise a private network, such as a local-area network, or a wide-area network, and/or a public network, such as the Internet. Further, conventional protocols and encryption methods may be utilized for electronically transmitting data over network 160. For example, http or ftp protocols may be used for data transfers, and encryption may be achieved through secure ftp or secure copy.

Although not shown, each of the computing devices in FIG. 1 may be connected to one or more input devices, such as a keyboard, a mouse, or some other type of means for inputting data to computing device. Further, each of the computing devices may be connected to one or more display devices, such as a monitor or any other visual and/or audiovisual output device.

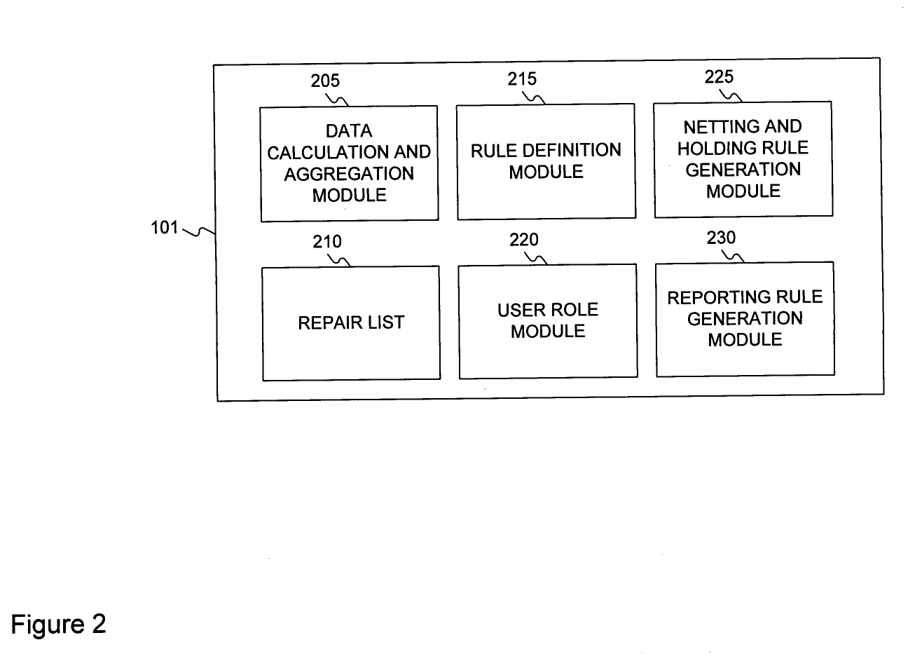

Calculation engine 101 may include a number of modules or applications for performing various functions. These modules or applications may be software-enabled or computerized. For example, as further described below with reference to FIG. 2, configuration engine 101 may include a data calculation and aggregation module 230, as well as a rule definition module 205, a netting and holding rule generation module 215, a reporting rule generation module 225, and a user role module 220. Other modules may also be provided, such as a repair list 210.

In the example of FIG. 1, server 100 receives data from position data feeds 170a-170n and static data feeds 180a-180n, and communicates with database 110 to retrieve and store data. Database 110 may comprise any conventional database management system. Examples include, but are not limited to, an Oracle® relational database management system, a Microsoft® SQL Server, and Sybase®. In one embodiment, database 110 is configure to perform various functions, such as data retrieval or calculations.

Consistent with embodiments of the invention, electronically received data may be filtered and mapped by data interface 105 before being processed by calculation engine 101. Specifically, data interface 105 may filter, map, and load data from position data feeds 170a-170n and/or static data feeds 180a-180n by utilizing a data loading tool, such as Informatica®. Further, data interface 105 may comprise a job scheduling tool, such as AUTOSYS®, that periodically initiates the data filtering, mapping, and loading. Data interface 105 may also directly upload static data files into database 110. Moreover, data interface 105 may replicate data into database 110 from other systems using replication technology, such as Sybase® DirectConnect Replication.

In one embodiment, database 110 follows a star-schema model comprising a fact table. Data interface 105 populates database 110 based on data from position data feeds 170a-170n and static data feeds 180a-180n. During the database load process, data interface 105 populates the fact table based on data from static data feeds 180a-180n. Dimensional data from server 100 and position data feeds 170a-170n may be filtered and mapped by data interface 105. Further, data interface 105 populates dimensional tables of database 110 based on data from position data feeds 170a-170n, which may be sent in a dimensional data format. When populating the dimensional tables, data interface 105 may resolve static data references by checking the dimensional data corresponding to the data in the fact table and inserting dimensional surrogate keys along with the fact data. In an exemplary embodiment, the database population process is divided into the following three processes: (i) lookup of foreign-keys or surrogate keys based on the data from static data feeds 180a-180n; (ii) load the fact table with data from static data feeds 180a-180n and retrieved surrogate keys; and (iii) register events when the dimensional data from server 100 and position data feeds 170a-170n is not found in a repair list table (see repair list 210 discussed below with reference to FIG. 2).

As stated above, calculation engine 101 runs calculations on data provided from position data feeds 170a-170n and static data feeds 180a-180n. Further, calculation engine 101 generates alerts for authorized users 120 based on calculation options entered by authorized users 120a-120n, for example. Consistent with one embodiment, two types of calculation options may be provided: (i) holding calculation options; and (ii) alert generation options. Holding calculation options may specify the subset of positions to be considered for calculation, implemented as holding rules, and the aggregation levels and options, implemented as netting rules. Alert generation options, implemented as reporting rules, may specify the alert types and holding thresholds that govern alert generation. Alert types include, for example, high-level and low-level alerts. High-level alerts may require more immediate attention and actions, such as selling down financial positions in a jurisdiction to abide by the rules and regulations in the jurisdiction, prior to the required disclosure of those financial positions. Low-level alerts may provide early warnings and may or may not require immediate attention and actions. In one embodiment, alerts may be viewed by authorized users through browser-based displays with drill down capabilities.

In accordance with still further embodiments of the invention, reports may be generated for authorized users by calculation engine 101 and/or database 110. Reports may be generated or otherwise provided on a periodic basis, such as hourly, daily, weekly, or any pre-defined period of time. Reports may also be generated on-demand or an ad-hoc basis. The report generation and ad-hoc query capabilities may be provided by a reporting tool, an example of which is Business Objects® products by Web Intelligence®. Browser-based user interfaces, including rules and options entry forms, alerts, and reports, may be developed using high-level programming languages such as Java®, C#, or ASP+. Further, browser-based user interfaces may be deployed on servers such as a WebSphere application server and Apache HTTP server.

In one embodiment, browser-based displays of alerts and reports, or a dashboard display, may be grouped by region or jurisdiction and provide authorized users with the capability to drill down to the positions that triggered the alert. Further, authorized users may be capable of viewing data in pre-defined report formats with drill down capabilities. Authorized users 120 may also generated historic reports based on stored data and selection criteria such as region, jurisdiction, reportable event type, holding rule, reporting rule, and/or date range.

System administrator 115 may have various administrative responsibilities over the automated system 10, such as maintaining the mapping and filtering capabilities and/or other options in data interface 105, maintaining the data stored in database 110, and maintaining access rights and privileges of users. System administer 115 may also track a repair list (see repair list 210 shown FIG. 2) and resolve data errors reported to and stored in the repair list. Additionally, or alternatively, the responsibility of resolving errors identified in the repair list may be assigned to one or more of the authorized users 120a-120n. System administrator 115 may also administer static data, including identifying static data issues and communicating with the proprietors of static data feeds 180a-180n to resolve data issues or errors.

In one embodiment, administrator 115 and/or authorized user(s) 120 may override static data using static data override functionality (“static data override” hereinafter). Static data override allows a user, such as administrator 115 or an authorized user 120, to supplement or override static data by specifying specific data such as shares outstanding, equity/non-equity issue classification, and/or derivative and underlying issue relationships. Static data override may also allows the user to choose from a list of issues and decide on the override type, such as outstanding shares, underlying issue maintenance, and share class type.

To override outstanding shares and share class type, static data override provides a list of static data feeds with the corresponding underlying issues and the issues' outstanding shares and class types. For the selected issue or issues, the user can change the outstanding shares source or override it with a manual or default value. To provide issue maintenance, static data override provides a list of issues with the corresponding underlying issues and conversion factors. The user can select the underlying issue from any one static data feed or enter the issue manually. If the user enters the issue manually, then the user needs to add a conversion factor. The user may choose to set the override to default values.

Feed Specifications

Consistent with embodiments of the invention, data received from position data feeds 170a-170n may be electronically transmitted to and processed by data interface 105 in accordance with feed specifications. The feed specifications may predefined and specify one or more formats for transmitting data to server 100. For example, the feed specifications may specify what data parameters are anticipated from each of the position data feeds, and the manner in which to transmit that data (e.g., the order or structure of the requested data, preferred codes for identifying the issue and issuer, significance of digits, etc). The use of feed specifications may be particularly useful for ensuring data consistency in cases where position data feeds 170a-170n comprise different source systems for storing financial position data of the entity.

For purposes of illustration, an exemplary data structure defined by a feed specification is provided below in Table I. As shown by Table I, the exemplary data feed structure comprises three main sections: (i) a header record; (ii) a position/underlying record; and (iii) a trailer record. Each of these sections contain one or more data fields. Although not shown in Table I, the feed specification may define codes and/or other formatting for representing the values in each of the fields (e.g., Record Type, Source System ID, etc).

TABLE I

| | Field(s) | Purpose |
|---|---|---|
| Header | Record Type | Indicating that this record is a header |
| Record | | |
| | Source System ID | System ID of the system sending the data |
| | Creation Date/Timestamp | The date/time that the file is created |
| Position/ | Record Type | Indicating that this record is a position |
| Underlying | | |
| Record | | |
| | Product/Instrument Type | Indicates the instrument type for that |
| | | position, e.g., cash equity, preferred equity, |
| | | equity option, equity futures, convertible |
| | | bond, etc |
| | Valuation Date (TD) | The date that the position is for as of trade |
| | | date |
| | TD quantity | Capacity of the position |
| | Book or Portfolio Number | Identifies a contact point for a compliance |
| | from Local System | officer when investigating this position |
| | Book or Portfolio Name | Any further description for the book or |
| | | portfolio number provided. Facilitates |
| | | investigations and mappings to legal entities |
| | Long/short indicator | Indicate long or short position |
| | Market/Exchange Code | Identifies the exchange code the position |
| | | was traded |
| | Legal Entity ID of Position | Legal entity which is beneficial owner |
| | Owner | |
| | Position Record ID | A unique numeric identifier for each record; |
| | | should be sequential |
| Trailer | Record Type | Indicating that this record is a header |
| Record | | |
| | Record Count | Indicates total number of records in the file |

Data interface 105 may process data from position data feeds 170a-170n in accordance with the feed specifications. Processing may include formatting data to ensure consistency with the specified data format(s), resolving missing data, flagging data inconsistencies or errors, and mapping data to associate it with the correct business units or legal entities. In one embodiment, static data references (e.g., issue or issuer name, issue class, number of outstanding shares, exchange(s) of issue, conversion factor, issuer ID, country code of original product issuer, issue to issuer links, industry codes of underlying issuer, etc) may be resolved automatically by polling or analyzing the data from static data feeds 180. Unresolved items or data errors may be posted to a repair list, so that they may be manually reviewed and resolved by an administrator or another authorized user.

Consistent with an embodiment of the invention, the feed specifications may apply different data reporting rules according to specific business scenarios (e.g., proprietary trading, trust accounts, etc.) and/or the nature or capacity in which the entity or its related legal entities operate (e.g. management center, booking center, custody center). Such data reporting rules may be applied to each of the position data feeds (source systems) to restrict the type of position data that is transmitted to the calculation engine. This may assist the calculation engine from double-counting of financial positions received from more than one of the entity's locations, the data for which is stored in a respective one of the position data feeds.

In a financial institution, such as a large bank, different data reporting rules may exist with respect to the manner in which financial positions or holdings are sourced. These data reporting rules may include, for example, a management center approach, a booking center approach, and a custody center approach. In a management center approach, data may be sourced from the location where the financial positions are managed, regardless of the location where the financial products are booked. In a booking center approach, the data may be sourced from the location's system where the positions are booked, regardless of the location where the financial products are managed. In a custody center approach, the data is sourced from the custodian, regardless where the financial products are managed and booked. The above are merely examples of data reporting rules that may be implemented through the feed specifications. Therefore, these examples should not be interpreted as limiting the scope of the invention.

As indicated above, position data feeds 170a-170n provide position data to server 100. The position data provided by the position data feeds 170 may represent positions or holdings of one or more legal entities of a financial institution. Examples of legal entities include, for example, business centers, reporting centers, management centers, booking centers, and custody centers. Depending on the structure of the financial institution, data may need to be collected from one or more of the position data feeds.

By way of further example, FIG. 3 illustrates an exemplary structure of a financial institution. In FIG. 3, group 300 represents a financial institution with a number of legal entities. Each of the legal entities may be wholly owned or controlled by the financial institution. The legal entities may be structured into one or more business groups 310a-310n. Each of the business groups may conduct specific type(s) of business, which may be divided by region or jurisdiction.

By way of example, assume group 300 represents a large financial firm, such as UBS AG. Examples of business groups 310a-310n within group 300 may include: UBS Corporate Center, UBS Global Asset Management, UBS PaineWebber, UBS Warburg, and UBS Wealth Management & Business Banking. These business groups may be grouped based on the type of business conducted. For example, UBS Corporate Centre conducts group management, UBS Global Asset Management conducts asset management, and UBS PaineWebber conducts deal brokerage. Within each of these business groups, one or more legal entities may be provided, such as UBS Warburg LLC, UBS O'Connor LLC, UBS PaineWebber Inc., etc.

As shown in the example of FIG. 3, legal entities are the basic operating units of group 300. The legal entities may have financial or otherwise reportable positions. To fulfill reporting obligations, group 300 may be required to aggregate financial holdings of the legal entities associated with each of the business groups. Therefore, computerized system 10 may be utilized to aggregate holdings from the particular legal entities of group 300. Such features are further described below, with reference to exemplary embodiments of the invention.

Calculation Engine

Referring to FIG. 2, an detailed diagram of an exemplary configuration of calculation engine 101 is provided. As shown in, calculation engine 101 includes a rule definition module 205, a repair list 210, a netting and holding rule generation module 215, a user role module 220, a reporting rule generation module 225, and a data calculation and aggregation module 230. Each of these modules or components may be implemented with software.

Rule definition module 205 may prompt and collect data from authorized users 120 to define or modify netting, holding, and reporting rules. To this end, rule definition module 205 may provide one or more graphical user interfaces (GUIs) for display on a terminal or screen of authorized users 120. A browser or similar software may be used to display the GUIs on an authorized user's computing device.

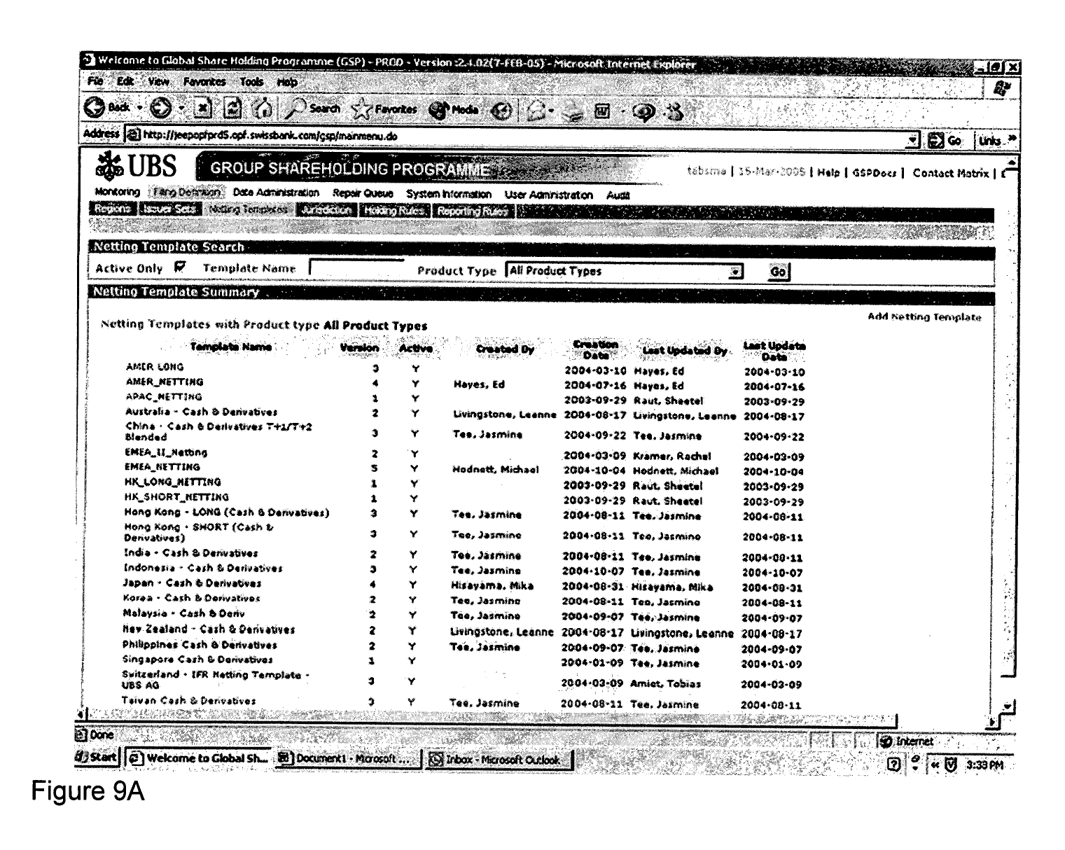

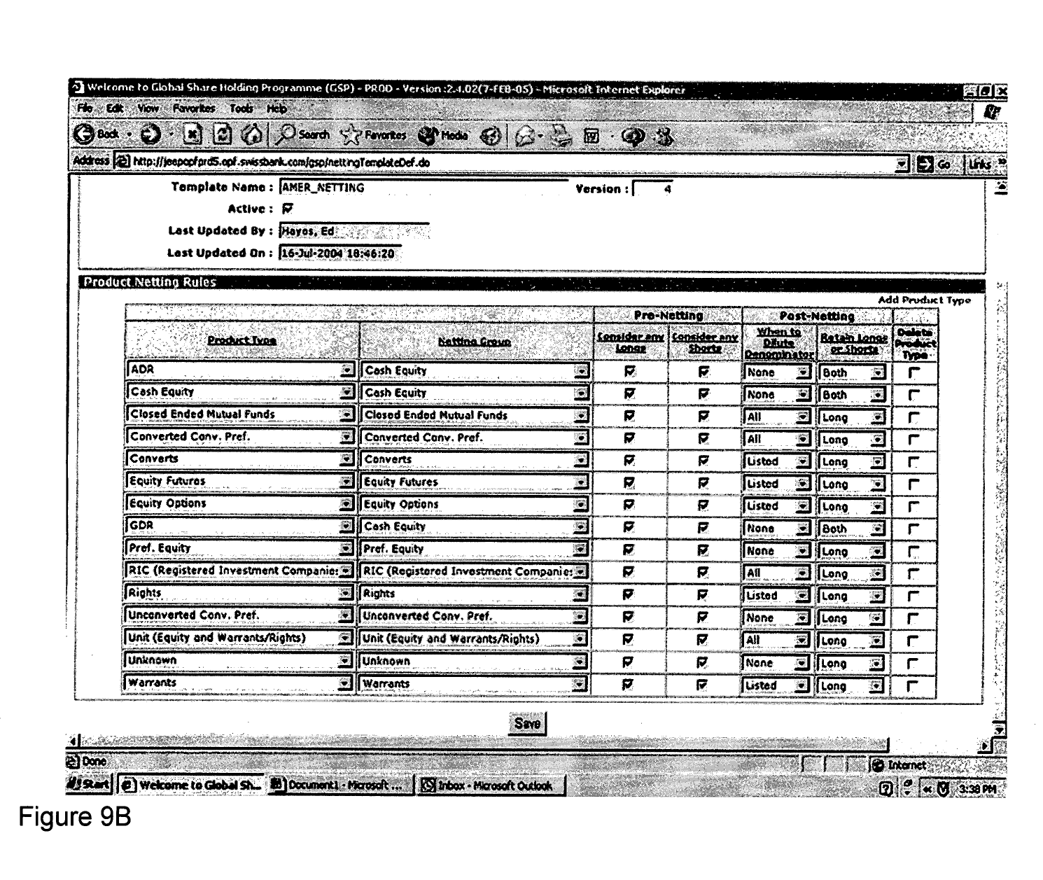

In one embodiment, to facilitate the defining or modifying of rules, templates are provided. Templates may be created by a system administrator or other authorized user and displayed on a user's terminal. Templates may include any combination of data entry fields, drop-down windows, selection boxes and other fields to enable rules to be defined or modified. By way of example, templates may comprise fields for entering a template name, version, author name, and date of creation or update. Drop-down fields and selection boxes may also be provided to select the jurisdiction, issuer (e.g., all, exchange/domiciled, industry, etc.), financial product types (ADR, baskets, cash equity, closed ended mutual funds, equity options, etc.), and/or other parameters for rules. In one embodiment, the layout of a template for each type of rule (netting, holding, reporting) may be uniform or standardized so that authorized users become more familiar and proficient with each rule that they define or modify. Examples of templates are further described below and illustrated in FIGS. 9-13.

Netting and holding rule generation module 215 generates netting and holding rules. The rules are based on data collected from authorized users by rule definition module 205. In one embodiment, rule definition module 205 passes the data collected for a netting rule or a holding rule to module 215. Netting and holding rule generation module 215 then interprets the data and generates a corresponding rule for storage in database 110. In embodiments were templates are used, rule definition module 205 may pass the data collected from a template to netting and holding rule generation module 215. Module 215 then interprets the data and stores the same in database 110 using a suitable data structure, such as a relational table or flat file. Netting and holding rules stored in database 110 may be stored and retrieved by netting and holding rule generation module 215 using a rule name and/or version.

As shown in FIG. 2, calculation engine 101 further includes a reporting rule generation module 225. Reporting rule generation module 225 may operate in a similar manner to that of netting and holding rule generation module 215. Specifically, module 225 generates rules (in this case, reporting rules) based on the data collected from authorized users by rule definition module 205. Rule definition module 205 may pass the data collected for a reporting rule to module 225. Reporting rule generation module 225 then interprets the data and generates the corresponding rule for storage in database 110. Once again, in embodiments were templates are used, rule definition module 205 may pass the data collected from a template to reporting rule generation module 225 and module 225 may interpret the data and store the same in database 110. Reporting rules, stored as using a relational table, flat file, etc. in database 110, may be retrieved by reporting rule generation module 225 by rule name and/or version.

Data calculation and aggregation module 230 calculates and aggregates financial positions of an entity. The financial positions may be calculated based on data from position data feeds 170 and static data feeds 180, and the rules defined by authorized users. Module 230 may be initialized or scheduled to calculate financial positions at predetermined intervals (e.g., hourly, daily, weekly, etc) or substantially simultaneously with the receipt of data updates.

As noted above, data from position data feeds 170 and static data feeds 180 may be processed and stored in database 110. To calculate financial positions, data calculation and aggregation module 230 may retrieve the financial position data from database 110, as well as stored static data. Further, module 230 retrieves and applies the netting and holding rules generated by netting and holding rule generation module 215. The netting and holding rules may be applied per jurisdiction or region. Data calculation and aggregation module 230 may also generate alerts and reports for authorized users based on the reporting rules collected by reporting rule generation module 225.

As shown in FIG. 2, data from position data feeds 170 and static data feeds 180 is filtered by data interface 105. Occasionally, data may be found to contain errors, such as missing or incomplete data items, financial products that cannot be correctly identified by issue or issuer, etc. To address data errors or inconsistencies, a repair list 210 may be provided. Repair list 210 may be module for generating and storing a repair list of filtered data for manual inspection and intervention by a system administrator or other authorized users. The repair list may be displayed to authorized users who are assigned the responsibility of investigating, correcting or otherwise disposing of flagged data.

In the embodiment of FIG. 2, user role module 220 of calculation engine 101 is responsible for storing defined user roles (e.g., in database 110) and controlling access to system 10. As stated above, access rights and privileges of an authorized user can be defined by system administrator 115. User role module 220 may provide one or more graphical user interfaces (GUIs) to allow system administrator 115 to define roles and assign users to roles. In one embodiment, each role is defined with a set of rights and privileges. When an authorized user is assigned to a defined role, that user inherits the rights and privileges of the defined role. The rights and privileges may control what data a user can view (e.g., financial position data, alerts, warnings, etc.), as well as the privileges available to the user, such as defining netting, holding and/or reporting rules. Access privileges may include, for example, the right to create, update and/or delete. Further, access rights and privileges may be limited at any level, such as business group, legal entity, jurisdiction, region, etc. When a user logs into system 10, the user's rights and privileges may be checked by user role module 220 to control what data and privileges are made available to that user.

In another embodiment, teams are defined using module 220. Each team may comprise a group of users and each user may belong to one or more teams. Further, one or more roles may be assigned to each team and, optionally, jurisdiction or business group designations may be declared for each team. In operation, module 220 may analyze the above-noted designations to determine the complete set of rights and privileges available to a user.

Data Aggregation and Reporting

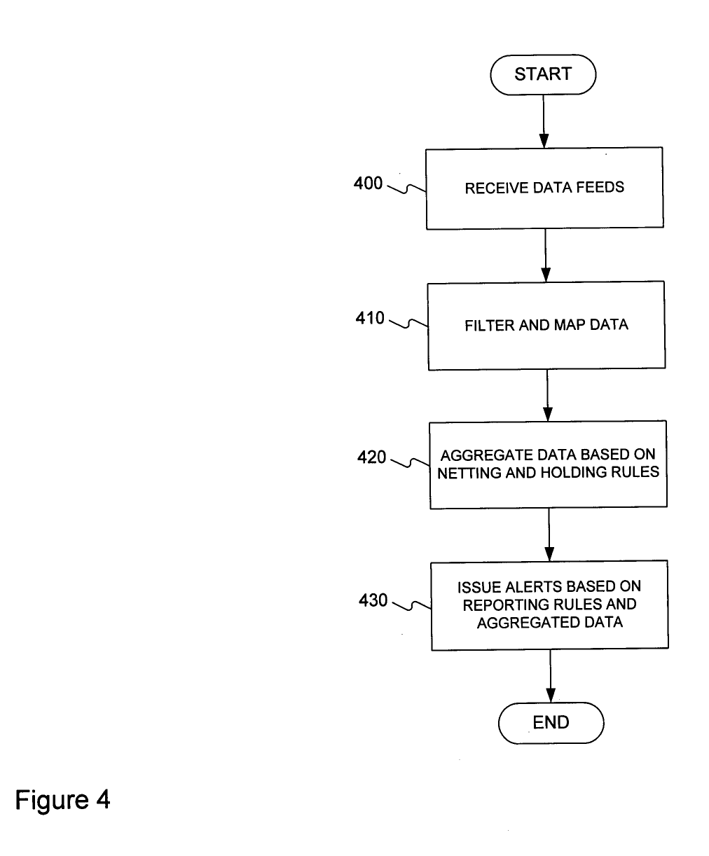

FIG. 4 shows a flow diagram of an exemplary method for monitoring and reporting financial positions of an entity. For purposes of illustration, FIG. 4 will be described with reference to the exemplary system 10 of FIG. 1. It will be appreciated, however, that the exemplary method may be implemented with other systems, consistent with the principles of the invention.

At the start of the process indicated in stage 400, server 100 of the automated system 10 receives data from one or more source systems (position data feeds 170) and static sources (static data feeds 180). In one embodiment, feed specifications are provided to ensure that data is sent correctly. The feed specifications may include, for example, data reporting rules to avoid double counting of financial positions based on data from the various source systems. Server 100 may receive the data on a periodic basis (e.g., daily or hourly), on demand, or substantially in real-time. Further, server 100 may receive the data via network 160. Server 100 may also receive the data through a direct upload of static data or by using a replication process (e.g., Sybase DirectConnect Replication).

In stage 410, server 100 may filter and map the data by using data interface 105 to prepare the data for aggregation in stage 420. By way of example, data interface 105 may process the data utilizing a data loading tool (e.g., Informatica). As described above, data interface 105 may filter the data to ensure the quality of the data and catch data errors. Examples of data errors feed data include a financial product that is associated with the wrong issuer, an inaccurate conversion ratio for an option, etc. In some cases, data interface 105 may use static data to resolve errors in the position data. In other cases, the data errors may be unresolved and, as result, posted to a repair list. Data feeds found to be complete may be mapped to associate, for example, financial positions with the correct business units or legal entities. All processed data may be stored in database 110.

Next, in stage 420, calculation engine 101 aggregates the financial position data stored in database 110 based on the applicable netting and holding rules. This calculation process may be done for each jurisdiction in which the entity has financial positions subject to reporting regulations. In one embodiment, calculation engine 101 selects financial positions based on a holding rule for a jurisdiction, and then aggregates selected financial positions based on a netting rule associated with the holding rule.

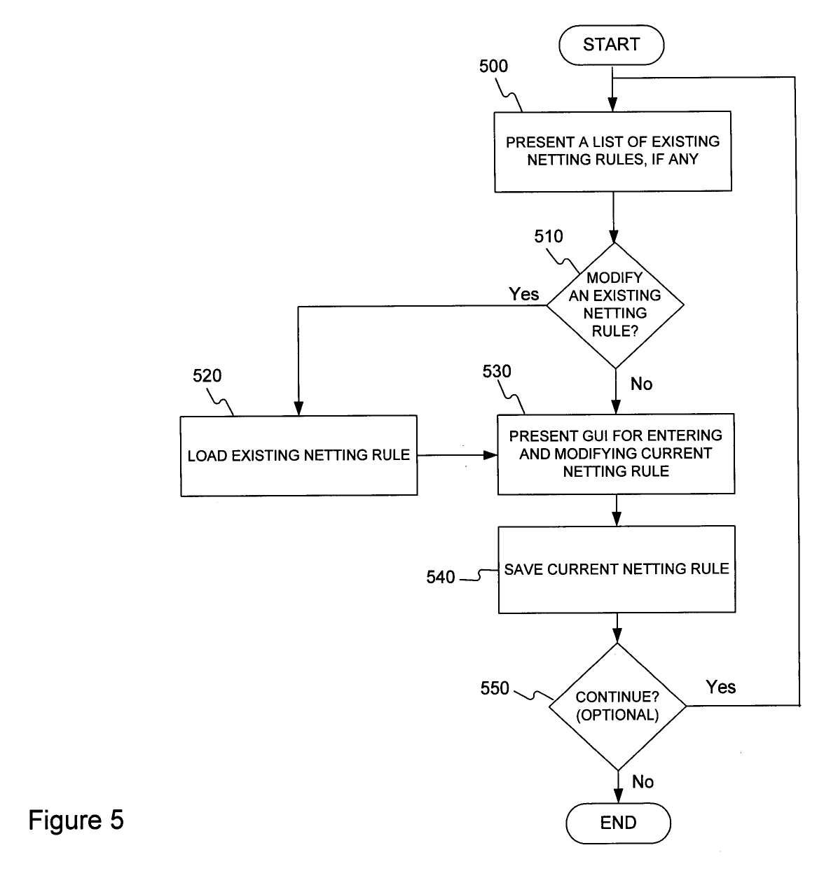

Consistent with embodiments of the invention, netting rules specify aggregation levels and options, i.e., how to aggregate different financial products and which financial products to net together. Netting rules define rules for netting positions, such as, for example: adding long positions (longs) and short positions (shorts) within netting groups for different financial products; including longs or shorts or both in pre-netting calculation; keeping the resulting long or short netted position in the post-netting output; and whether the position dilutes the denominator. As disclosed herein, netting rules are defined by authorized users 120. FIG. 5 illustrates an exemplary process for defining netting rules.

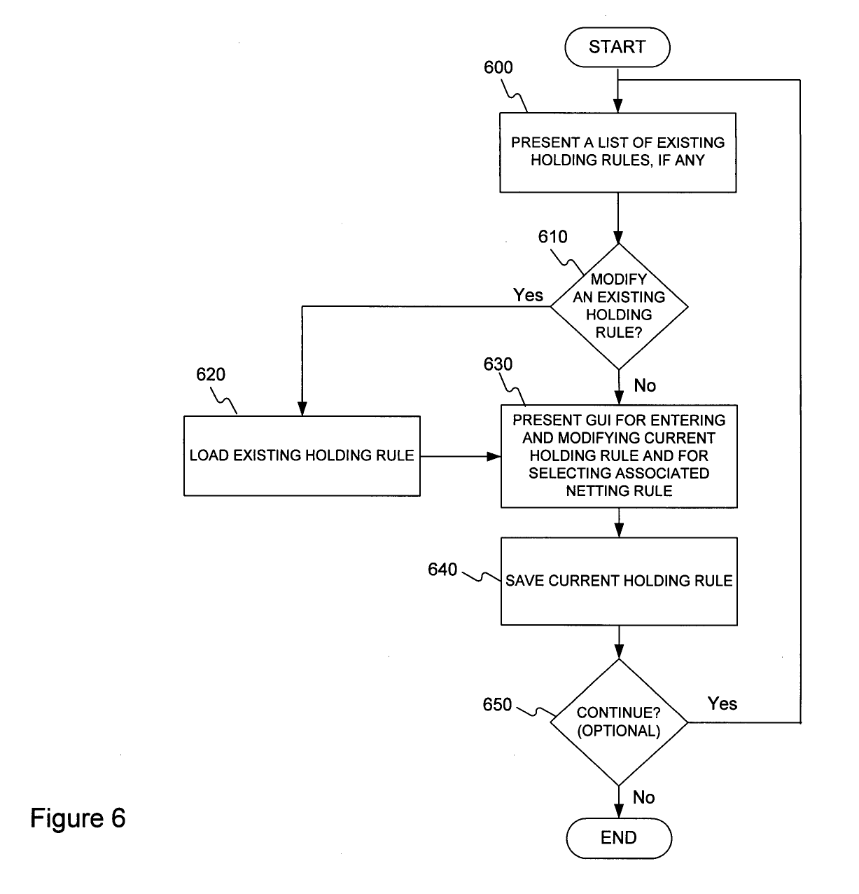

Holding rules specify the subset of positions to be considered for calculation, i.e., what financial positions are reportable in a jurisdiction. Holding rules define what positions to include based on a number of criteria, such as: position issuer or issue information (e.g., domicile in jurisdiction, exchanged in jurisdiction. etc.); product type (e.g., cash equity, indexes, ADR, warrants, etc.), associated netting rule; and associated netting method (e.g., within legal entity, within business group, group-wide, etc). Additional criteria for a holding rule may include: business group(s) or legal entity(ies); physical settlement status (e.g., physically settled, not physically settled, etc.); reporting level (e.g., share class level, issuer level, etc.); option type (e.g., long call, short call, long put, short put, etc.); trading capacity (e.g., proprietary, discretionary, advisory, etc.); and report date scheme (e.g., one day after trade date, two days after trade date, blended, etc.). As disclosed herein, holding rules may be defined by authorized users 120. FIG. 6 illustrates an exemplary process for defining holding rules.

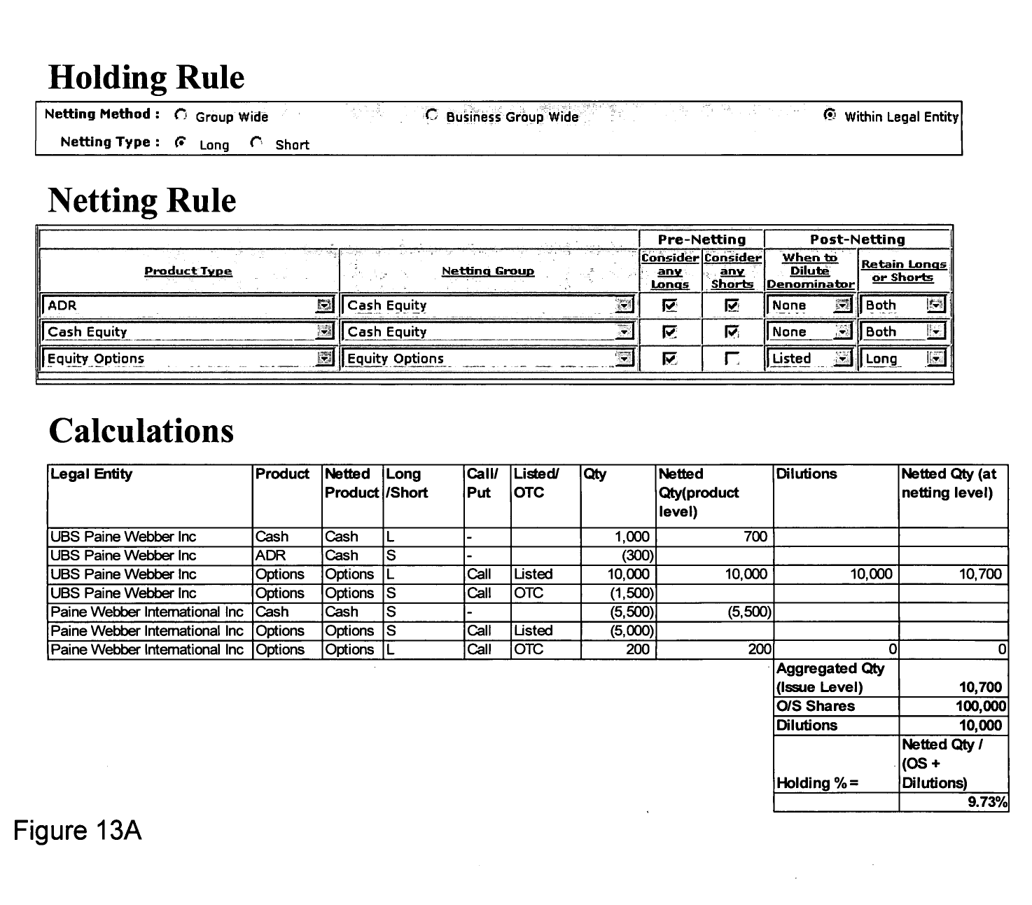

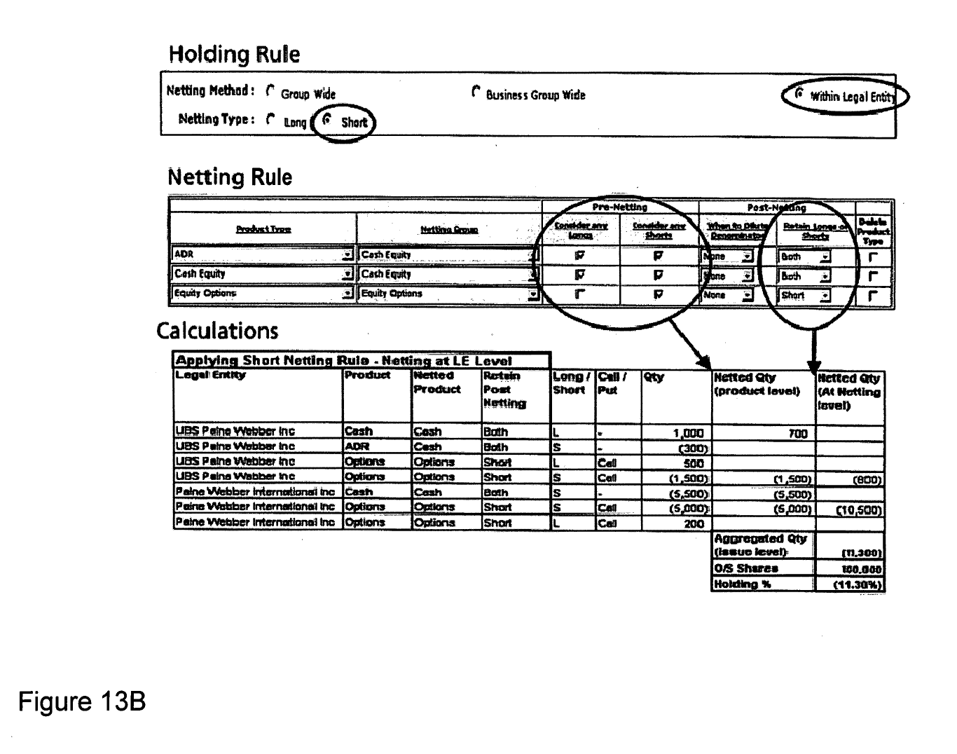

To provide a further understanding of how calculation engine 101 may select financial positions based on a holding rule and then aggregate the selected financial positions based on a netting rule, reference with now be made to the examples of FIGS. 13A and 13B.

Using the example shown in FIG. 13A, assume that a user (e.g., one of authorized users 120) selects a netting method and a netting type associated with a holding rule. In this case, the netting method is “Within Legal Entity” and the netting type is “Long” (i.e., consider only long positions). Although not shown in the figure, other criteria for the holding rule may also be defined, including the selection of the jurisdiction, the netting rule, etc. In this example, the netting rule includes specific criteria on how to aggregate different financial products and which financial products to net together. For example, ADRs and Cash Equity products are to be considered within the same netting group (“Cash Equity”) and have the same pre-netting and post-netting criteria. As shown in FIG. 13A, pre-netting criteria applies to netted quantities at the product level, whereas post-netting criteria applies to netted quantities at the netting level (i.e., defined by the netting method and netting type). Equity options, on the other hand, are treated separately within a different netting group (“Equity Options”) and for pre-netting only long positions are considered and for post-netting only long positions are retained.

Based on the holding an netting rules shown in FIG. 13A (e.g., net within legal entity, consider only long positions, etc), calculation engine 101 calculates the financial positions for each legal entity based on the data stored in database 110. In this example, calculations are shown for two legal entities: UBS Paine Webber Inc. and Paine Webber International Inc. First, calculation engine 101 considers, at the product level, financial positions that the user has selected for pre-netting. For positions within each legal entity, calculation engine 101 groups ADRs and cash equities (the “Cash Equity” netting group) and considers both longs and shorts for pre-netting, and groups equity options (the “Equity Options” netting group) and considers only longs. As a result, for UBS Paine Webber Inc., calculation engine 101 nets the cash equity and ADR positions together and considers both longs (i.e., 1,000) and shorts (i.e., 300). Calculation engine 101 subtracts the 300 shorts from the 1,000 longs, resulting in a netted quantity of 700 longs at the product level. Further, for UBS Paine Webber Inc., calculation engine 101 nets equity options but considers only longs (i.e., 10,000), resulting in a netted quantity of 10,000 longs at the product level. Moreover, for UBS Paine Webber Inc., calculation engine 101 dilutes the denominator (e.g., number of outstanding shares) by a specifed quantity (i.e., 10,000) when the equity option is listed on an exchange or otherwise has traded shares. Likewise, for Paine Webber International, Inc., calculation engine 101 considers 5,500 shorts for cash equity and 200 longs for equity options at the product level.

After aggregating selected financial positions at the product level, calculation engine 101 aggregates the selected positions at a netting level. Continuing with the example shown in FIG. 13A, calculation engine 101 considers, at the netting level, financial positions that the user has selected for post-netting. Based on user selection, calculation engine 101 retains both longs and shorts for ADR and cash equity positions, and retains only longs for equity option positions. Therefore, for UBS Paine Webber Inc., calculation engine 101 nets the 700 long cash equity and ADR positions (both of “Cash Equity” netting group) and the 10,000 long equity options position (of “Equity Option” group) into an aggregated quantity of 10,700 longs. Moreover, for Paine Webber International, Inc., calculation engine 101 nets cash equity position (5,500 shorts) equity options and 200 longs for equity options at the product level into an aggregate quantity of 5,300 shorts. However, since the selected netting type is to retain long positions only, the aggregated quantity for equity options is effectively 0. Combining the aggregated quantity of 10,700 (for “Cash Equity” netting group) and 0 (for “Equity Options” group) results in an aggregated quantity of 10,700 at the issue level. Dividing the aggregated quantity (i.e., 10,700) against the denominator (e.g., number of outstanding shares determined from the static data, i.e., 100,000 plus a selected dilution quantity, i.e., 10,000) results in a holding percentage of 9.73 percent after applying the exemplary holding and netting rules shown in FIG. 13A. Dilution of the denominator may serve to reflect the diluting effect of stock options (granted to, e.g., employees and executives) and other securities convertible into common equity on the holding percentage of selected positions.

In another example shown in FIG. 13B, calculation engine 101 applies another set of holding and netting rules (e.g., net within legal entity, consider only short positions, etc.). Specifically, in this example, calculation engine 101 groups ADR and cash equity positions into a “Cash Equity” group and considers both longs and shorts for pre-netting, and groups equity options into a “Equity Options” group and considers only shorts for pre-netting. Therefore, for the legal entity UBS Paine Webber Inc., calculation engine 101 nets the illustrated cash equity and ADR positions and considers both longs (i.e., 1,000) and shorts (i.e., 300). Calculation engine 101 subtracts the 300 shorts from the 1,000 longs, resulting in a netted quantity of 700 longs at the product level. Further, for the legal entity UBS Paine Webber Inc., calculation engine 101 nets the equity options but considers only shorts (i.e., 1,500), resulting in a netted quantity of 1,500 shorts at the product level. Likewise, for Paine Webber International, Inc., calculation engine 101 considers 5,500 shorts for the “Cash Equity” group and 5,000 shorts for the “Equity Options” group at the product level.

After aggregating selected financial positions at the product level, calculation engine 101 aggregates the selected positions at a netting level. Specifically, continuing with the example shown in FIG. 13B, calculation engine 101 considers, at the netting level, financial positions that the user has selected for post-netting. Based on the netting rules, calculation engine 101 does not dilute the denominator for any of the product types, retains both longs and shorts for ADR and cash equity positions, and retains only shorts for equity option positions. Thus, for UBS Paine Webber Inc., calculation engine 101 nets the 700 long cash equity and ADR positions (both of the “Cash Equity” netting group) and the 800 short equity options position (of the “Equity Option” group) into an aggregated quantity of 800 shorts. Furthermore, for Paine Webber International, Inc., calculation engine 101 nets the 5,500 shorts of the cash equity positions and the 5,000 shorts for the equity options at the product level into an aggregated quantity of 10,500 shorts. Adding the aggregated quantity of 800 shorts for the “Cash Equity” netting group and the 10,500 shorts for the “Equity Options” group results in an aggregated quantity of 11,300 shorts at the issue level. Dividing the aggregated quantity of 11,300 shorts against the number of outstanding shares determined from the static data (i.e. 100,000) results in a holding percentage of 11.3 percent in the example shown in FIG. 13B.

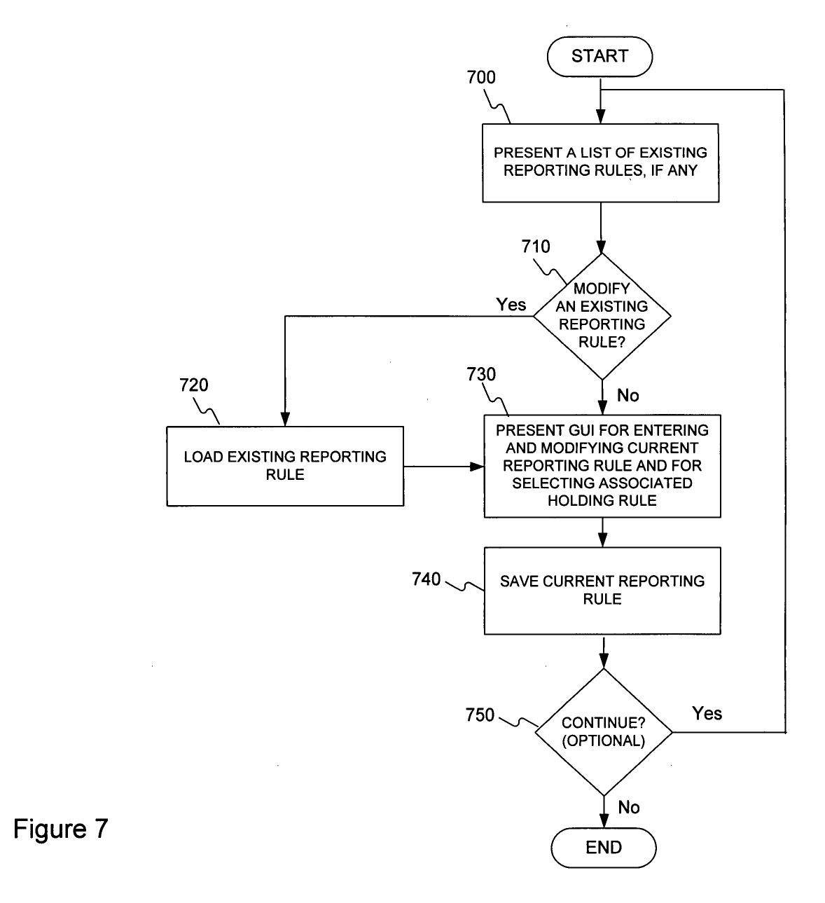

Referring again to FIG. 4, in stage 430 calculation engine 101 issues alerts or warnings based on the aggregated data calculated in stage 420 and the applicable reporting rules. Consistent with an aspect of the invention, the alert generation options, implemented as reporting rules, specify the alert types and holding thresholds that govern alert generation. As disclosed herein, reporting rules define criteria for triggering reporting requirements, such as: an associated holding rule; a movement above (i.e., position holdings that move above a set percentage); a movement below (i.e., position holdings that move below a set percentage); a movement relative (i.e., position holdings that move between minimum and maximum percentage range relative to the latest breach percentage); a movement within (i.e., position holdings that move between minimum and maximum percentage range for a specified increment); and a snapshot (i.e., position holdings that are above a set percentage). Additional reporting rule criteria may include, for example: timing of report (e.g., daily, weekly, monthly, etc.); dashboard target (e.g., daily, periodic, not on dashboard, etc.); expected action (e.g., high-level alert, low-level alert, etc.); and report assignment. As further disclosed herein, reporting rules are defined by authorized users 120. FIG. 7 illustrates an exemplary process for defining reporting rules.

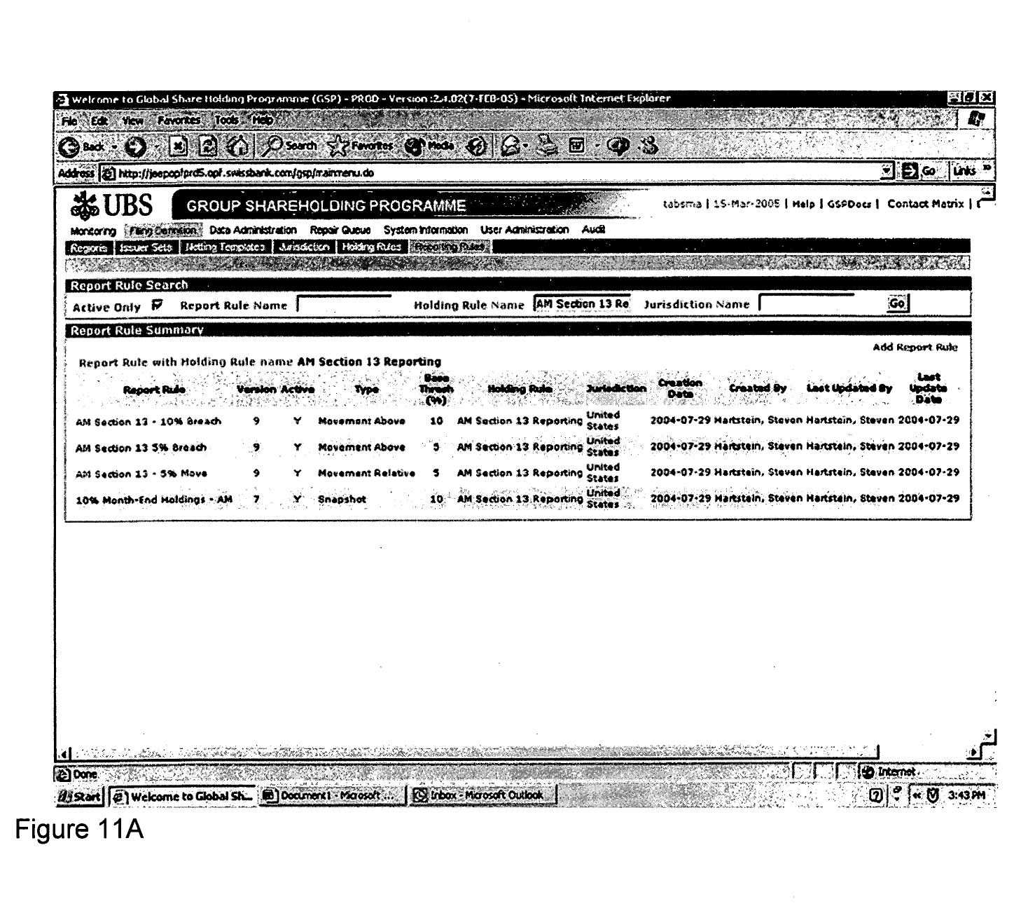

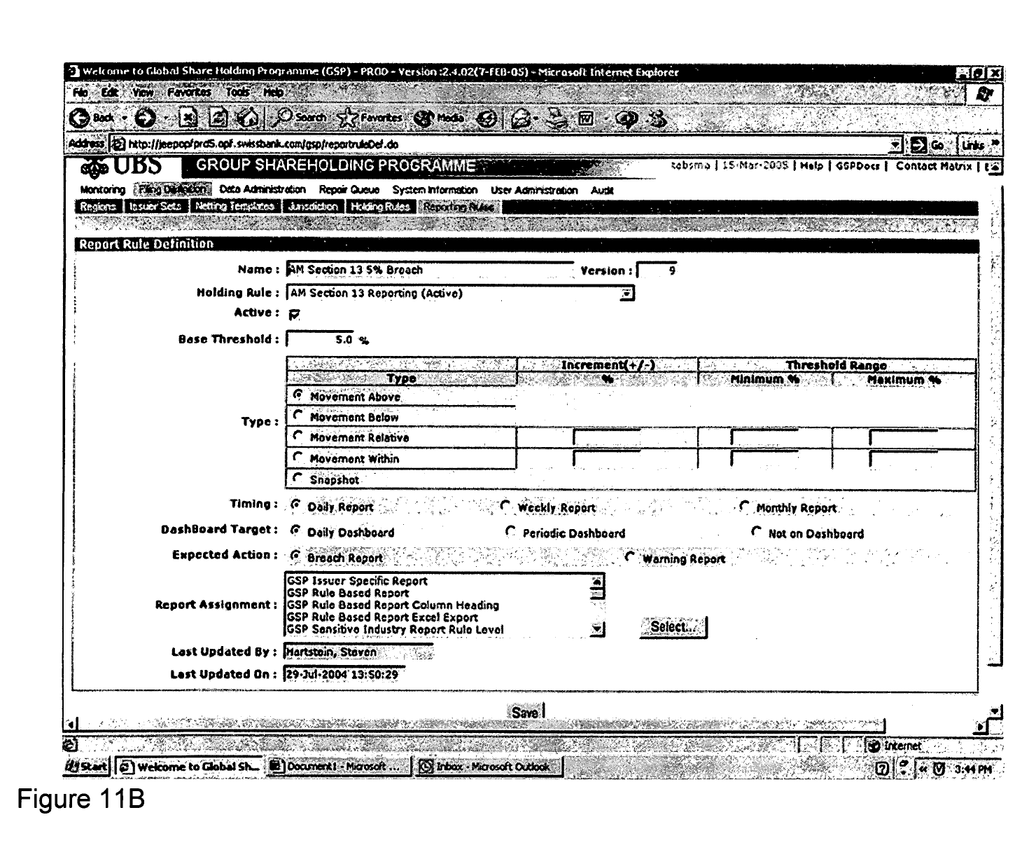

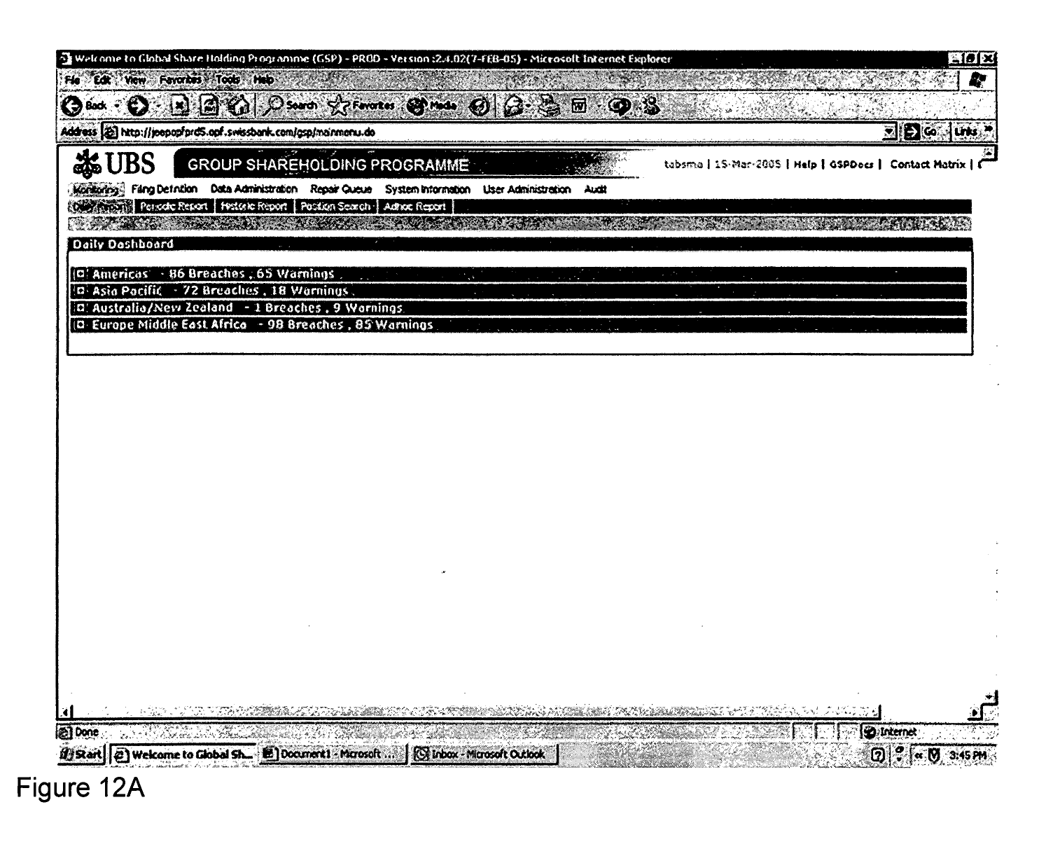

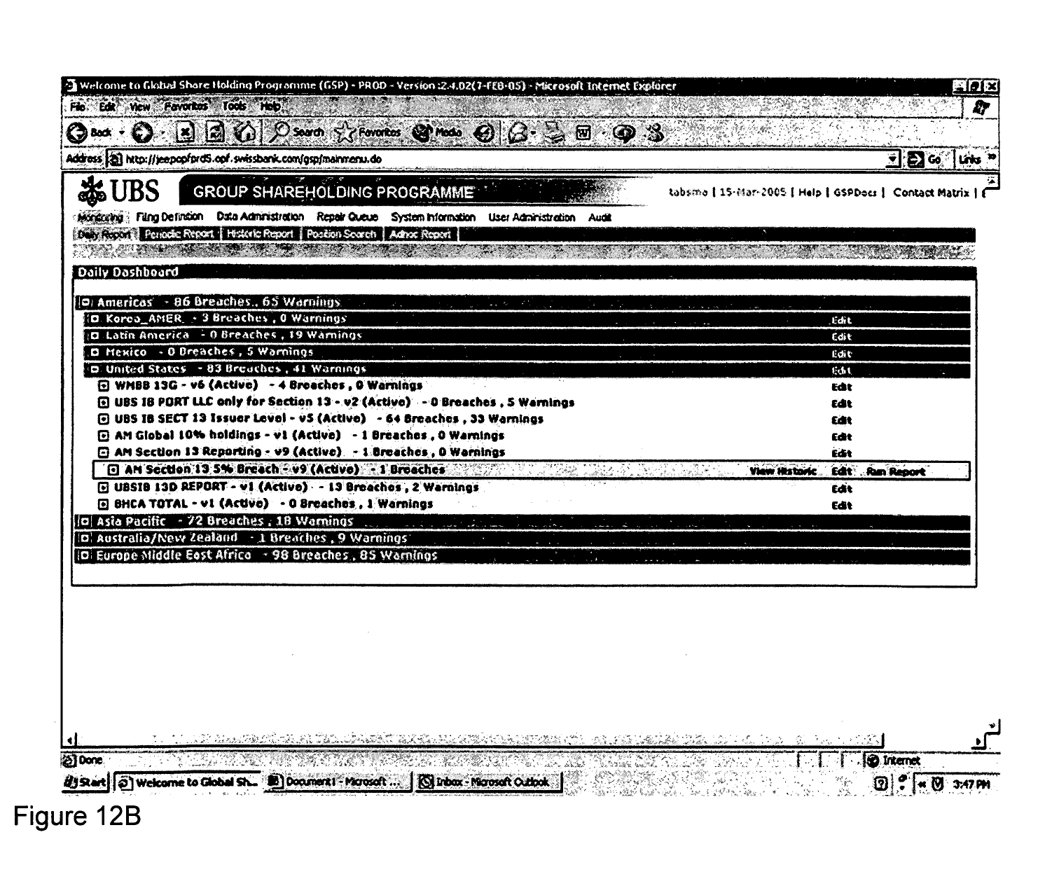

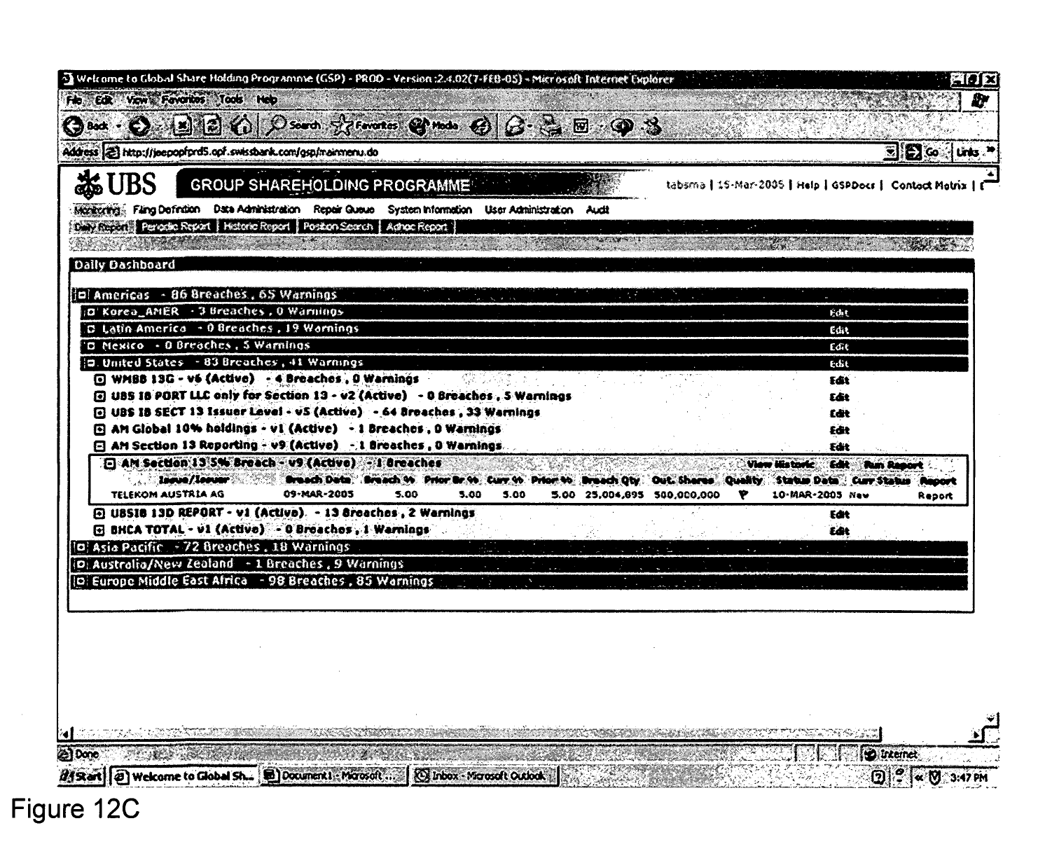

Calculation engine 101 generates alerts and reports that may be viewed by authorized users 120 through, for example, browser-based displays with drill-down capabilities. FIGS. 12A-C illustrate an exemplary dashboard displays that provide increasing levels of detail based on user selection and a selected reporting rule (e.g., an “AM Section 13.5% Breach” reporting rule, as defined in FIG. 11B).

In FIG. 12A, calculation engine 101 presents an authorized user with an exemplary dashboard display. In the example, it is assumed that the authorized user has the right to access and view alerts or warnings for four specific regions (i.e., Americas, Asia Pacific, Australia/New Zealand, and Europe Middle East Africa). When the user selects a region (e.g., Americas), the dashboard display may expand to display specific jurisdictions that make up the “Americas” region and the number of alerts or warnings in each jurisdiction. For example, Americas region contains the United States as a jurisdiction, which has 83 high-level alerts (labeled as “Breaches”) and 41 low-level alerts (labeled as “Wamings”). When the user selects a jurisdiction as shown in FIG. 12B, calculation engine 101 may further expands the dashboard to group and display the holding rule(s) associated with the selected jurisdiction (i.e., United States) and the number of alerts, if any, generated based the calculations under each holding rule. The number of alerts may be broken down according to alert type (e.g., number of high-level alerts and number of low-level alerts). Further, if the user selects a specific holding rule (e.g., “AM Section 13 Reporting”), calculation engine 101 displays the reporting rule(s) associated with the selected holding rule and the number and type of alerts generated from each reporting rule (e.g., “AM Section 13 5% Breach”).

As shown in FIG. 12, if the user selects a specific reporting rule, calculation engine 101 displays further details of the alert(s) related to the selected reporting rule (e.g., issue/issuer, alert date, alert %, prior alert %, current %, status date, etc.). In the example of FIG. 12, an alert has been generated under the “AM Section 13 5% Breach” reporting rule. The details for this alert indicate the issue/issuer “Telekom Austria AG” and alert date “09, Mar. 2005,” among other details. At this point, an authorized user may be given the option to further investigate the alert, including to view historic data related to the issue/issuer or to run a report to analyze the alert. After investigating the warning, a decision may made whether to submit a formal report, to sell down the position, etc.

Defining Netting, Holding and Reporting Rules

FIG. 5 illustrates a flow diagram of an exemplary method for defining netting rules or accessing and modifying existing netting rules. Consistent with an embodiment of the invention, the user (e.g., one of the authorized users 120) may enter netting rules via a pre-defined netting template. In stage 500, calculation engine 101 presents to the user a list of existing netting rules, if any. The list may be presented via a display, such as that shown in FIG. 9A. As shown in the exemplary list of FIG. 9A, calculation engine 101 may identify each existing netting rule by, for example, rule name, version number, active status (yes (“Y”) or no (“N”)), name of author or creator, creation date, name of last updater, and last update date. The user may also search for a netting rule using one or more search criteria, e.g., active status, netting rule name, product type, etc.

Next, in stage 510, calculation engine 101 determines whether the user wishes to modify an existing netting rule or define a new netting rule. If calculation engine 101 determines that the user wishes to modify or view an existing netting rule, then in stage 520 calculation engine 101 loads the selected netting rule based on the netting rule selected by the user. The process in FIG. 5 then proceeds to stage 530.

In stage 530, calculation engine 101 presents a netting rule GUI for modifying an existing netting rule, as shown by the example in FIG. 9B. For ease of reference, the netting rule GUI may be in the same form as the template used for defining or creating a new netting rule. However, in the case that an existing netting rule has been selected by the user, the displayed template of the netting rule GUI is not blank but displays all of the parameters for the existing netting rule. Through the GUI, the user may modify or change any of the parameters for the existing netting rule. For example, the user may change the netting rule name, version number, and/or active flag status of the existing netting rule. Further, other parameters for the existing netting rule may be updated or altered, such as the product types (e.g., ADR, cash equity, closed ended mutual funds, etc.), netting group (e.g., ADR, cash equity, closed ended mutual funds, etc.), pre-netting rules, and post-netting rules.

If the user does not wish to modify an existing netting rule (stage 510; No), then the process will also proceed to stage 530. However, in this case, the user desires to define a new netting template. As a result, all of the parameters in the displayed template GUI for the netting rule will be blank, allowing the user to enter data and make the appropriate selections for the new netting rule.

The process enters stage 540 when the user indicates a desire to save the netting rule. At this stage, all of the user's entries to modify an existing netting rule or to define a new netting rule are identified by the calculation engine 101 and the resultant netting rule is save in database 110. After saving the netting rule in stage 540, calculation engine 101 may determine whether the user wishes to continue the process at stage 550 in FIG. 5. If the user wishes to continue, the process returns to stage 500, otherwise calculation engine 101 terminates the process.

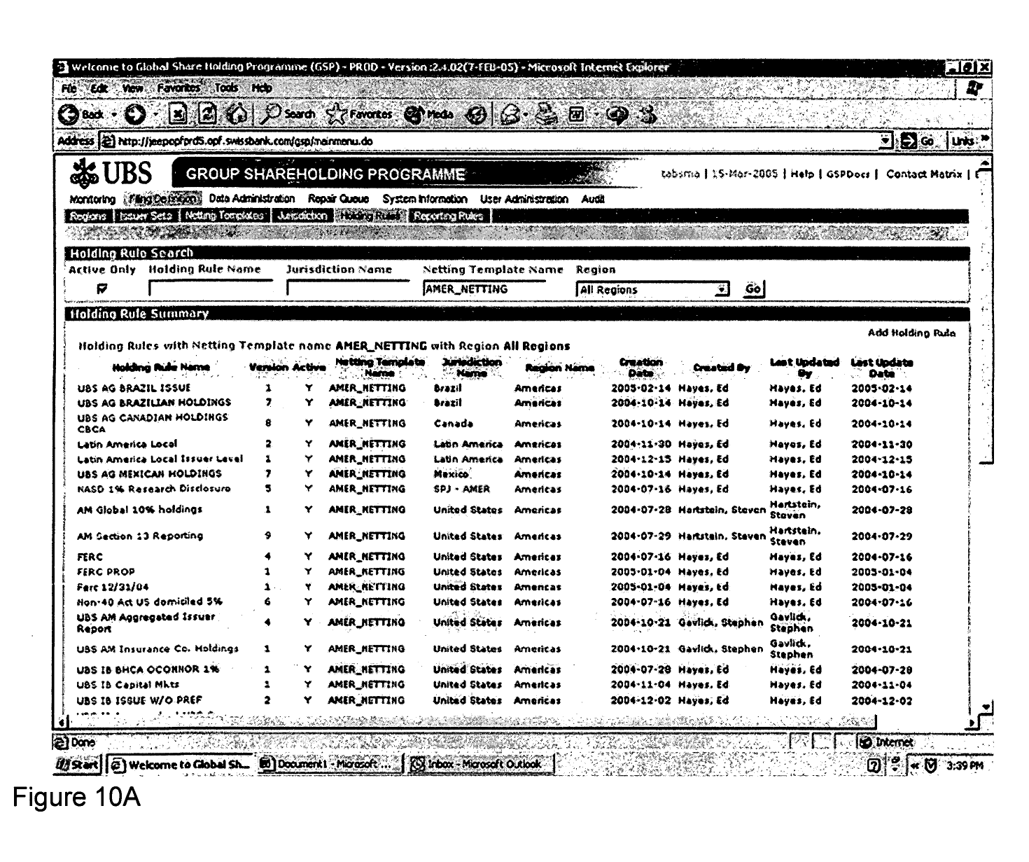

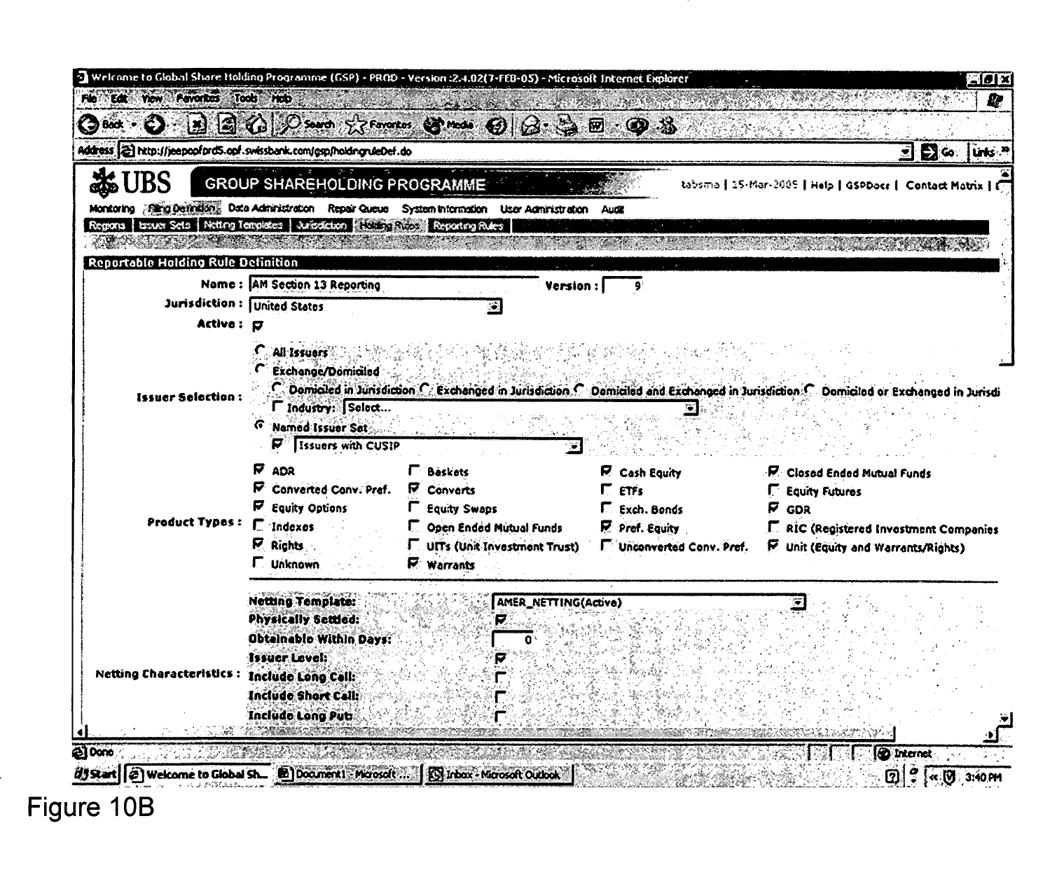

FIG. 6 illustrates a flow diagram of an exemplary method for defining new holding rules or accessing and modifying existing holding rules. The user (e.g., one of the authorized users 120) may enter holding rules via a pre-defined holding template. In stage 600, calculation engine 101 presents to the user a list of existing holding rules, if any. The list may be presented via a display, such as that shown in FIG. 10A. As shown in the exemplary list of FIG. 1A, calculation engine 101 may identify each existing holding rule by, for example, holding rule name, version number, active status (“Y” or “N”), associated netting rule name, jurisdiction name, region name, name of creator, creation date, name of last updater, and last update date. The user may also search for a holding rule using one or more search criteria, e.g., active status, holding rule name, jurisdiction name, associated netting rule name, region, etc.

Next, in stage 610, calculation engine 101 determines whether the user wishes to modify an existing holding rule or define and add a new holding rule. If calculation engine 101 determines that the user wishes to modify or view an existing holding rule, then in stage 620 calculation engine 101 loads the selected holding rule based on the holding rule selected by the user. The process in FIG. 6 then proceeds to stage 630.

In stage 630, calculation engine 101 presents a holding rule GUI for modifying an existing holding rule, as shown by the example in FIG. 10B. Once again, for ease of reference, the holding rule GUI may be in the same form as the template used for defining or creating a new holding rule. However, in the case that an existing holding rule has been selected by the user, the displayed template of the holding rule GUI is not blank but displays all of the parameters for the existing holding rule. Through the GUI, the user may modify or change any of the parameters for the existing holding rule. For example, the user may change the holding rule name, version number, jurisdiction, and active status of the existing holding rule. Further, other parameters for the existing holding rule may be updated or altered, such as the issuer selection (e.g., all issuers, exchanged/domiciled in jurisdiction, named issuer set, etc.), product type (e.g., cash equity, indexes, ADR, warrants, etc.), netting characteristics (e.g., name of associated netting rule, include long call, include short call, etc.), and netting method (e.g., within legal entity, within business group, group-wide, etc.). Additional user-definable holding rule criteria include, for example: business group(s) or legal entity(ies); physical settlement status (e.g., physically settled, not physically settled, etc.); reporting level (e.g., share class level, issuer level, etc.); option type (e.g., long call, short call, long put, short put, etc.); trading capacity (e.g., proprietary, discretionary, advisory, etc.); and report date scheme (e.g., one day after trade date, two days after trade date, blended, etc.).

If the user does not wish to modify an existing holding rule (stage 610; No), then the process also proceeds to stage 630. However, in this case, the user desires to define a new holding template. As a result, all of the parameters in the displayed template GUI for the holding rule will be blank, allowing the user to enter data and make the appropriate selections for the new holding rule.

The process enters stage 640 when the user indicates a desire to save the holding rule. At this stage, all of the user's entries to modify an existing holding rule or to define a new holding rule are identified by the calculation engine 101 and the resultant holding rule is save in database 110. After saving the holding rule in stage 640, calculation engine 101 may determine whether the user wishes to continue the process at stage 650 in FIG. 6. If the user wishes to continue, the process returns to stage 600, otherwise calculation engine 101 terminates the process.

FIG. 7 illustrates a flow diagram of an exemplary method for defining new reporting rules or accessing and modifying existing reporting rules. The user (e.g., one of the authorized users 120) may enter reporting rules via a pre-defined reporting template. In stage 700, calculation engine 101 presents to the user a list of existing reporting rules. As shown in the exemplary list of FIG. 1 1A, calculation engine 101 may identify each existing reporting rule by, for example, the rule name, version number, active status, type (e.g., movement above, movement below, movement relative, movement within, snapshot, etc.), associated holding rule name, jurisdiction name, name of creator, creation date, name of last updater, and last update date. The user may also search for an existing reporting rule using one or more search criteria, e.g., active status, reporting rule name, associated holding rule name, jurisdiction name, etc.

Next, in stage 710, calculation engine 101 determines whether the user wishes to modify an existing reporting rule or add a new reporting rule. If calculation engine 101 determines that the user wishes to modify or view an existing reporting rule, then in stage 720 calculation engine 101 loads the selected reporting rule based on the reporting rule selected by the user. The process in FIG. 7 then proceeds to stage 730.

In stage 730, calculation engine 101 presents a reporting rule GUI for modifying an existing reporting rule, as shown by the example in FIG. 11B. Once again, the reporting rule GUI may be in the same form as the template used for defining or creating a new reporting rule. However, in the case that an existing reporting rule has been selected by the user, the displayed template of the reporting rule GUI is not blank but displays all of the parameters for the existing reporting rule. Through the GUI, the user may modify or change any of the parameters for the existing reporting rule. For example, the user may change the reporting rule name, associated holding rule name, version number, jurisdiction, and active status of the existing reporting rule. Through reporting rule GUI, other criteria may also be modified or entered by the user such as the base threshold (expressed as a %) and rule type (movement above, movement below, movement relative between a minimum and maximum percentage range relative to the latest breach percentage, movement within a minimum and maximum percentage range for a specified increment, and snapshot for position holdings that are above the base threshold). Examples of additional reporting rule criteria include: timing of report (e.g., daily, weekly, monthly, etc.); dashboard target (daily, periodic, not on dashboard, etc.); expected action (e.g., high-level alert, low-level alert, etc.); and report assignment.

The process enters stage 740 when the user indicates a desire to save the reporting rule. At this stage, all of the user's entries to modify an existing reporting rule or to define a new reporting rule are identified by the calculation engine 101 and the resultant reporting rule is save in database 110. After saving the reporting rule in stage 740, calculation engine 101 may determine whether the user wishes to continue the process at stage 750 in FIG. 7. If the user wishes to continue, the process returns to stage 700, otherwise calculation engine 101 terminates the process.

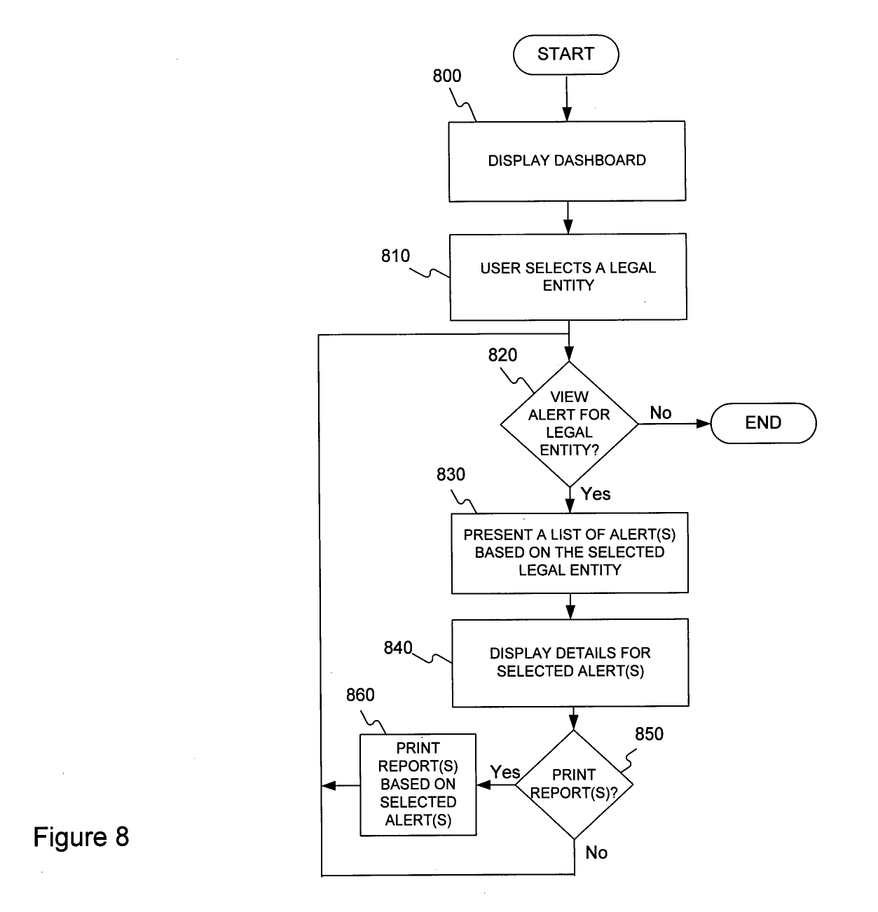

FIG. 8 shows an exemplary flow diagram of a method for displaying a dashboard of alerts associated with legal entities, and accessing the alerts and generating reports based on the alerts. In stage 800, calculation engine 101 generates and displays a dashboard (see, e.g., FIGS. 12A-C) to an authorized user. The dashboard may be periodic (e.g., daily, weekly, etc) or historic. In an exemplary implementation, calculation engine 101 first displays available regions to the user (see FIG. 12A). When the user selects a region, the dashboard may expand to display jurisdictions that make up the selected region and the number of alerts in each jurisdiction. Further, if the user selects a jurisdiction, calculation engine 101 may expand the dashboard to display holding rule(s) associated with the selected jurisdiction and the total number of alerts generated by reporting rule(s), if any, for positions aggregated under each holding rule (see FIG. 12B).

Referring again to FIG. 8, in stage 810 the user selects a reporting rule and calculation engine 101 displays the number and type of alert(s) associated with the reporting rule, if any. Then, calculation engine 101 in stage 820 determines whether the user wishes to view details for the alert(s) associated with the selected reporting rule. If the user does not wish to view the associated alert(s), then the process in FIG. 8 ends. If the user wishes to view the associated alert(s), then in stage 830 calculation engine 101 presents to the user details on the alert(s) associated with the selected reporting rule (see FIG. 12C). For each alert, details may be displayed such as the issue/issuer name for the financial position, alert date, alert percentage, prior alert percentage, current percentage, prior percentage, outstanding shares, data quality flag, status date, and current status. One or more of these fields may be displayed with a hyperlink to allow a user to select the same and drill-down to view additional information. Further, for each alert, other hyperlinks may be provided to enable a user to run a report (ad-hoc or predefined), view historic data, edit the alert, etc. By way of example, the user may view a historic dashboard by region, jurisdiction, reportable event type, holding rule, reporting rule, date range, daily report detail, etc.

In stage 850, calculation engine 101 determines whether the user wishes to print report(s). If the user wishes to print report(s), calculation engine 101 in stage 860 prints report(s) based on selected alert(s). Process in FIG. 8 then returns to stage 820 to determine whether the user wishes to continue viewing alert(s) associated with selected reporting rules.

The foregoing descriptions of the invention have been presented for purposes of illustration and description. They are not exhaustive and do not limit the invention to the precise form disclosed. Modifications and variations are possible in light of the above teachings or may be acquired from practicing of the invention. For example, the described implementation includes software, but the present invention may be implemented as a combination of hardware and software or in hardware alone. Further, while certain exemplary methods have been described, it will be appreciated that the order of the method may be rearranged and stages or steps may be substituted, modified, combined or otherwise altered.

Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM.

Other embodiments of the invention will be apparent to those skilled in the art from consideration of the specification and practice of the invention disclosed herein. Therefore, the specification and examples should be considered as exemplary only, with a true scope and spirit of the invention being indicated by the following claims.

What is claimed is:

1. A computerized system for monitoring financial positions of an entity on a group-wide basis, the system comprising:
a user interface for defining netting rules and holding rules, the holding rules defining what financial positions are reportable in each jurisdiction where the entity holds a financial position in a financial product, the netting rules defining how to aggregate financial positions;
a plurality of source systems for electronically storing and transmitting financial position data of the entity; and
a calculation engine adapted to electronically receive the financial position data transmitted from each of the plurality of source systems and to aggregate the financial position data in accordance with the netting rules and the holding rules.

2. The computerized system of claim 1, wherein the user interface comprises a graphical user interface (GUI) that is adapted to display at least one netting template to enable a user to define the netting rules, the netting template including at least one product type.

3. The computerized system of claim 1, wherein the user interface comprises a GUI that is adapted to display at least one holding template to enable a user to define the holding rules for each jurisdiction.

4. The computerized system of claim 3, wherein the user interface comprises a GUI that is adapted to display the at least one holding template to enable a user to associate one of the holding rules to one of the netting rules.

5. The computerized system of claim 4, wherein the calculation engine is further adapted to select reportable financial positions in accordance with a holding rule and net the reportable financial positions in accordance with the associated netting rule of the holding rule, wherein the holding rule is one of the holding rules.

6. The computerized system of claim 4, wherein the user interface comprises a GUI that is adapted to display at least one reporting template to enable a user to define reporting rules for each jurisdiction, wherein each of the reporting rules define criteria for triggering alerts for reporting requirements, the criteria comprising at least one of a holding threshold and a position movement.

7. The computerized system of claim 6, wherein the user interface comprises a GUI that is adapted to display the at least one reporting template to enable a user to associate one of the reporting rules to one of the holding rules.

8. The computerized system of claim 1, wherein the calculation engine is further adapted to map the financial position data in accordance with a feed specification provide to the plurality of source systems.

9. The computerized system of claim 8, wherein the plurality of source systems further comprises:
at least one position data feed for providing financial position data corresponding to the financial product traded, the financial position data including data indicating at least one of: a financial product type, a class of financial product, an issuer of financial product, a quantity traded, a type of trade, and a time of trade; and
at least one static data feed for providing static data corresponding to the financial position, the static data including data indicating at least one of: an issue name, an issuer name, a quantity of outstanding shares, an exchange of issue, a conversion factor, an issuer identification, a country code of product issuer, an issue to issuer link, and an industry code of underlying issuer.

10. The computerized system of claim 9, wherein the position data feed provides the financial position data on a periodic basis.

11. The computerized system of claim 8, wherein the feed specification comprises a data importation rule for each of the plurality of source systems.

12. The computerized system of claim 8, wherein the feed specification comprises:
a header record for indicating an identification of one of the plurality of source systems;
at least one position record, wherein each position record indicates a product type and a valuation date of one of the financial positions; and
a trailer record for indicating a total number of the at least one position record.

13. The computerized system of claim 8, wherein the calculation engine is further adapted to filter out incomplete financial position data and send the incomplete financial position data to a repair list, wherein the incomplete financial position data contains financial positions that cannot be accurately reported and wherein the repair list prompts a user of the incomplete financial position data.

14. The computerized system of claim 8, further comprising:
a data interface adapted to filter out incomplete financial position data and to send the incomplete financial position data to a repair list, wherein the incomplete financial position data contains financial positions that cannot be accurately reported and wherein the repair list prompts a user of the incomplete financial position data.

15. The computerized system of claim 14, further comprising:
a system administration module adapted to provide a system administrator the capability to perform administrative functions, wherein the administrative functions include at least one of: maintaining the data interface, tracking the repair list, resolving data errors in the repair list, and overriding static data.

16. The computerized system of claim 15, wherein the calculation engine further comprises:
a user role module for allowing the system administrator to define user roles and assign users to user roles.

17. The computerized system of claim 16, wherein the user role module maintains, for each of the user roles, access rights to the system administration module and the user interface for defining netting rules and holding rules.

18. The computerized system of claim 17, further comprising:
a user interface for providing an alert dashboard to display alerts concerning reporting requirements, wherein the alert dashboard enables the user to view the alerts at different levels.

19. The computerized system of claim 18, wherein the alert dashboard enables the user to view the alerts at different levels based on a user role assigned to the user.

20. A computerized system for monitoring financial positions of an entity on a group-wide basis, the system comprising:
means for defining netting rules and holding rules, the holding rules defining what financial positions are reportable in each jurisdiction where the entity holds a financial position, the netting rules defining how to aggregate financial positions;
transmitting means for electronically storing and transmitting financial position data of the entity; and
means for electronically receiving financial position data transmitted from each of the plurality of source systems and aggregating the financial position data in accordance with the netting rules and the holding rules.

21. The computerized system of claim 20, further comprising means for selecting reportable financial positions in accordance with a holding rule and netting the reportable financial positions in accordance with the associated netting rule of the holding rule, wherein the holding rule is one of the holding rules.

22. The computerized system of claim 20, further comprising means for mapping the financial position data in accordance with a feed specification provided to the transmitting means.

23. The computerized system of claim 22, wherein the feed specification comprises a data importation rule for the transmitting means.

24. The computerized system of claim 22, further comprising means for filtering out incomplete financial position, wherein the incomplete financial position data comprises data that is determined to be incomplete based on the feed specification.

25. The computerized system of claim 20, further comprising:
filtering means for filtering out incomplete financial position data and sending the incomplete financial position data to a repair list, wherein the incomplete financial position data contains financial positions that cannot be accurately reported and wherein the repair list prompts a user of the incomplete financial position data.

26. The computerized system of claim 25, further comprising:
administration means for providing a system administrator the capability to perform administrative functions, wherein the administrative functions include at least one of: maintaining the filtering means, tracking the repair list, resolving data errors in the repair list, and overriding static data.

27. The computerized system of claim 26, further comprising:
means for enabling the system administrator to define user roles and assign users to user roles.

28. The computerized system of claim 27, further comprising:
alerting means for providing an alert dashboard to display alerts concerning reporting requirements, wherein the alert dashboard enables a user to view the alerts at different levels.

29. The computerized system of claim 28, wherein the alerting means enables a user to view the alerts at different levels based on a user role assigned to the user.

30. A computer-implemented method for monitoring financial positions of an entity on a group-wide basis, the method comprising:
defining netting rules and holding rules, the holding rules defining what financial positions are reportable in each jurisdiction where the entity holds a financial position, the netting rules defining how to aggregate financial positions;
electronically storing and transmitting, by a plurality of source systems, financial position data of the entity; and
electronically receiving financial position data transmitted from each of the plurality of source systems and aggregating the financial position data in accordance with the netting rules and the holding rules.

31. The computer-implemented method of claim 30, further comprising:
selecting reportable financial positions in accordance with a holding rule and net the reportable financial positions in accordance with the associated netting rule of the holding rule, wherein the holding rule is one of the holding rules.

32. The computer-implemented method of claim 30, further comprising:
mapping the financial position data in accordance with a feed specification provided to the plurality of source systems.

33. The computer-implemented method of claim 32, wherein the feed specification comprises a data importation rule for each of the plurality of source systems.

34. The computer-implemented method of claim 32, further comprising:
filtering out incomplete financial position data, wherein the incomplete financial position data comprises data that is determined to be incomplete based on the feed specification.

35. The computer-implemented method of claim 30, further comprising:
filtering out, with a data interface, incomplete financial position data and sending the incomplete financial position data to a repair list, wherein the incomplete financial position data contains financial positions that cannot be accurately reported and wherein the repair list prompts a user of the incomplete financial position data.

36. The computer-implemented method of claim 35, further comprising:
providing a system administrator the capability to perform administrative functions, wherein the administrative functions include at least one of: maintaining the data interface, tracking the repair list, resolving data errors in the repair list, and overriding static data.

37. The computer-implemented method of claim 36, further comprising:
allowing the system administrator to define user roles and assign users to user roles.

38. The computer-implemented method of claim 37, further comprising:
providing an alert dashboard to display alerts concerning reporting requirements, wherein the alert dashboard enables a user to view the alerts at different levels.

39. The computer-implemented method of claim 38, wherein alerting further comprises:
enabling a user to view the alerts at different levels based on a user role assigned to the user.
